(19) United States
(12) Patent Application Publication
(10) Pub. No.: US 2009/0211591 A1
(43) Pub. Date: Aug. 27, 2009

(54) MULTI-PATTERN LIP COSMETIC APPLICATOR

(76) Inventor: Ren I. Hwang, Arcadia, CA (US)

Correspondence Address: SHELDON MAK ROSE & ANDERSON PC, 100 Corson Street, Third Floor, PASADENA, CA, 91103-3842, US

(21) Appl. No.: 12/210,774

(22) Filed: Sep. 15, 2008

Related U.S. Application Data
(60) Provisional application No. 61/031,264, filed on Feb. 25, 2008.

(51) Int. Cl. A45D 40/26; A46B 17/02; B43K 19/00

(52) U.S. Cl. 132/200; 132/320; 401/48; 401/49

(57) ABSTRACT

A multi-pattern lip cosmetic applicator includes a base support having one or more primary regions with a multitude of small-delimited cells of predetermined geometry coated with lip cosmetics, which form a predetermined pattern transferable to the epidermal layer of a user's lips. The primary region may be a combination of two or more primary regions as part of a multi-pattern lip cosmetic applicator system. Wall-like projections defining the cells are arranged to proportionally vary the application in a variety of ways across the lips, with proportional mixing when two or more different cosmetics (which can be of different colors) are used. Also disclosed is a method for using the applicator as well as a method for making the applicator.

### CROSS-REFERENCE TO RELATED APPLICATIONS

This application claims the benefit of Provisional Application Ser. No. 61/031,264, filed Feb. 25, 2008, and which is incorporated herein by this reference.

### BACKGROUND OF THE INVENTION

1. Field of the Invention

The present invention relates to cosmetic applicators, and more particularly to cosmetic applicators for applying cosmetics in desired colors and textures to a subject's lips.

2. Prior Art

Numerous arrangements and configurations of lip cosmetic applicators are known in the art and have been employed to apply a coat of distinct cosmetic composition that gives a homogeneous color and texture over the user's lips, since it has been the fashion. It should be understood that the lip cosmetic formulations are complex composition having a solid, waxy base that contain colorings, preservatives, fragrances and flavors.

Innovations in the lip cosmetic industry focus on new colors and textures that can be applied homogeneously over the lips, not on an artistic combination of them. This new fashion statement would require several different steps with presently known lip cosmetic applicators, as well as a very high level of operator skill to render a satisfactory result.

Multi-color tube lipsticks have been proposed; however, all of them result in a homogenous mixture of those compounds during the application process, resulting in only one color being applied to the subject's lips.

Several types of thin, flat base lip cosmetic applicators have been proposed, all of them are limited to handle only one cosmetic compound per applicator, more than one different cosmetic compounds would result in an unpredictable smudging and mixing. Therefore, they are limited to mimic the function of those more conventional lip cosmetic applicators, such as tubes and pencil-shaped derivatives, which transfer one specific lip cosmetic compound per applicator and they are limited as low cost lip cosmetic samples. None of them offers a satisfactory way to provide a multi-color, multi-texture lip style.

Thus there is a need for an easy way to apply lip cosmetics in predetermined patterns of colors and textures, that facilitates smooth and measured transitions between distinct lip cosmetic compositions, and that is easy to use quickly and correctly.

### SUMMARY OF THE INVENTION

The present invention meets this need, providing a multi-pattern lip cosmetic applicator that is easily and inexpensively manufactured, disposable, hygienic, essential for the multitude of different patterns of colors and textures. The applicator includes a base support having one or more primary regions with a multitude of small-delimited cells of predetermined geometry coated with lip cosmetics, which form a predetermined pattern for determining a resulting pattern to be transferred to the epidermal layer of the lips. The primary region may be a combination of two or more primary regions as part of a multi-pattern lip cosmetic applicator system. More particularly in one aspect of the invention, the applicator includes a base support having a face surface adapted for movement in a stroke direction when pressed against a resilient body, the face surface having a primary region thereon, the primary region having an overall width transverse to the stroke direction; the primary region being subdivided into a plurality of delimited cells by walls rising from the face surface, at least some of the walls individually and/or collectively extending transversely relative to the stroke direction within an effective width of the primary region; and a cosmetic compound applied within the primary region between the walls, the compound being adapted for transfer to an external resilient body when the base support is moved inwardly and/or outwardly in the stroke direction with the face surface pressed against the resilient body, the compound being applied in a predetermined relative proportion across the effective width of the primary region.

At least a portion of the primary region can have localized lengths less than the overall length. At least some of the walls can project to irregular heights from the face surface for changing the amount of cosmetic to be transferred. At least some of the cells can form bands having varying length along the width of the primary region, also for varying the amount of cosmetic applied. Also, an irregular surface texture including small elevations and valleys can be formed within at least a portion of the primary region. The primary region can be one of a plurality of primary regions forming a composite primary region. The base support can be one of a plurality of base supports that lockingly engage a handle element. Alternatively, the base support can project in the stroke direction beyond an overall length of the primary region sufficiently to form a handle.

The primary region can be one of two primary regions separated by a hinge element for facilitating folding of the base support into a folded condition wherein the primary regions face outwardly for use against a facing pair of resilient bodies. The base support can also have engagable elements for facilitating positioning a plurality of base supports in orientations wherein primary regions thereof face outwardly for use against a facing pair of resilient bodies.

In another aspect of the invention, multi-pattern applicator includes the base support having the primary region with its plurality of delimited cells and transversely extending walls; a plurality of cosmetic compounds applied within the primary region between the walls, the compounds being adapted for transfer to an external resilient body when the base support is moved inwardly and/or outwardly in the stroke direction with the face surface pressed against the resilient body; and the small delimited cells having particular ones of the cosmetic compounds forming bands of varying length along the width of the primary region, the compounds being applied in a predetermined relative proportion across the effective width of the primary region. As above, at least some of the walls can project to irregular heights from the face surface. Preferably the face surface is textured within at least a portion of the primary region for enhanced mixing of the cosmetic compounds. Also, the primary region can be one of a plurality of primary regions forming a composite primary region. The base support can be one of a plurality of base supports that lockingly engage a handle element. Alternatively, the base support can project in the stroke direction beyond the overall length of the primary region sufficiently to form a handle.

Preferably the primary region includes a plurality of pattern regions, the pattern regions being separated by one or more of the walls, different cosmetic compounds being applied in at least two of the pattern regions for keeping the compounds separate until use of the applicator. The different cosmetic compounds can be of different colors.

As above, the primary region can be one of two primary regions separated by the hinge element for facilitating folding of the base support into a folded condition wherein the primary regions face outwardly for use against a facing pair of resilient bodies. The base support can also include engagable elements for facilitating positioning a plurality of base supports in orientations wherein primary regions thereof face outwardly for use against a facing pair of resilient bodies.

In another aspect of the invention, a multi-pattern applicator system includes a a plurality of applicators, each applicator comprising a base support having a primary region on a face surface thereof for movement in a stroke direction when pressed against a resilient body, the primary region having an overall width transverse to the stroke direction, the primary region being subdivided into a plurality of delimited cells by walls rising from the face surface, at least some of the walls individually and/or collectively extending transversely relative to the stroke direction within an effective width of the first primary region, and a cosmetic compound applied within the primary region between the walls, the compound being adapted for transfer to the resilient body when the base support is moved inwardly and/or outwardly in the stroke direction with the face surface pressed against the resilient body, the compound being applied in a predetermined relative proportion across the effective width of the primary region; and means for maintaining the base supports in a partially overlapped condition with at least portions of the primary regions being exposed to form a composite primary region for applying respective cosmetic compounds in predetermined relative proportions across an effective width of the composite primary region.

At least one of the base supports can have an additional primary region, those primary regions being separated by a hinge element for facilitating folding of that base support into a folded condition wherein its primary regions face outwardly for use against the facing pair of resilient bodies. In that configuration the at least one base support can have an aperture formed therein for exposing one or more primary regions of a different applicator. At least one of the base supports can project in the stroke direction beyond the overall length of its primary region sufficiently to form a handle.

The means for maintaining the base supports in a partially overlapped condition can include at least some of the base supports further having engagable elements for facilitating positioning those base supports in desired relations. The at least some base supports can have slidingly engagable rail and track elements for guiding the corresponding applicators to a desired relative position.

In a further aspect of the invention, a method for applying a predetermined combination of cosmetic compounds to a resilient body includes the steps of (a) providing an applicator including the base support having the primary region on a face surface thereof and being subdivided into the plurality of delimited cells by walls rising from the face surface, the plurality of cosmetic compounds applied within the primary region between the walls and forming bands of varying length along the width of the primary region; (b) pressing the face surface against the resilient body; and (c) moving the base support inwardly and/or outwardly in the stroke direction, the compounds being applied in a predetermined relative proportion across the effective width of the primary region.

In yet another aspect of the invention, a method for making a multi-pattern cosmetics applicator includes the steps of (a) providing a base support having a face surface; (b) forming walls rising from the face surface defining a primary region being subdivided into a plurality of delimited cells, at least some of the walls individually and/or collectively extending transversely within an effective width of the primary region; and (c) applying a plurality of cosmetic compounds within the primary region between the walls and forming bands of varying length along the width of the primary region, the compounds being adapted for transfer to an external resilient body when the base support is moved with the face surface pressed against the resilient body inwardly and/or outwardly in a stroke direction perpendicular to the effective width, thereby to form the cosmetics applicator. The method can include the additional step of removably affixing a transparent covering over the primary region. This method provides a cosmetic applicator that can withstand relatively rough handling in packaging, transportation and still maintain the integrity of different cosmetic compositions up to the moment of application.

It is of the utmost importance to emphasize that this invention is not intended to replace those conventional lip applicators, such as tubes and pencil-shaped derivatives that only transfer a single color and texture for each applicator, without applicator control of relative amounts of cosmetic to different regions of a user's lips. However, time has come for a novel lip style.

The multi-pattern lip cosmetic applicator disclosed in this patent will open to a new and, until now, unconventional multi-color and multi-texture lip fashion that can be used stand alone or in combination with those more conventional lip cosmetic applicators.

### DRAWINGS

These and other features, aspects, and advantages of the present invention will become better understood with reference to the following description, appended claims, and accompanying drawings, where:

FIG. 1 is a face view of a multi-pattern lip cosmetics applicator according to the present invention;

FIG. 2 is a perspective view of the cosmetics applicator of FIG. 1;

FIG. 3 is a perspective view showing a portion of the cosmetics applicator of FIG. 1;

FIG. 4 is a diagrammatic sectional detail view of the applicator on line 4-4 of FIG. 3;

FIG. 5 is a perspective view showing the cosmetics applicator of FIG. 1 in a partially folded condition;

FIG. 6 is a perspective view the cosmetics applicator of FIG. 1 in a fully folded condition;

FIG. 7 is a side view of the folded cosmetics applicator of FIG. 6;

FIG. 8 is a side view showing the cosmetics applicator of FIG. 6 being used between lips of a subject;

FIGS. 9AA, 9BB, 9CC, and 9DD are respective face views as in FIG. 1, showing respective patterns of lip cosmetic compounds;

FIGS. 9A, 9B, 9C, and 9D show applied cosmetic patterns on the subject's lips resulting from use of the cosmetic applicators 9A, 9B, 9C, and 9D, respectively;

FIG. 10 is a perspective view showing components of a two-piece alternative configuration of the cosmetics applicator of FIG. 1;

FIG. 11 is a perspective view showing the cosmetics applicator of FIG. 10 in a partially folded condition;

FIG. 12 is a face view of the cosmetics applicator of FIG. 10 in a fully folded condition;

FIG. 13 is a perspective view of the cosmetics applicator of FIG. 12;

FIG. 14 is a perspective view as in FIG. 11, one of the components having an alternative configuration;

FIG. 15 is a perspective view as in FIG. 14, the one of the component having a different alternative configuration;

FIG. 16 is a perspective view as in FIG. 14, the one of the component having a another alternative configuration;

FIG. 17 is a perspective view as in FIG. 10, showing another two-piece configuration of the cosmetics applicator of FIG. 1;

FIG. 18 is a perspective view of three-piece alternative configuration of the cosmetics applicator of FIG. 1 in a partially folded condition;

FIG. 19 is a perspective view of the cosmetics applicator of FIG. 18 in a fully folded and assembled condition;

FIG. 20 is a perspective view showing a system of three cosmetics applicators, each having a different alternative configuration of the applicator of FIG. 1 and being in a partially folded condition;

FIG. 21 is a perspective view as in FIG. 20, showing two of the applicators in a nested condition, the third applicator in position for optional nesting;

FIG. 22 is a perspective view as in FIG. 17, showing yet another two-piece configuration of the cosmetics applicator of FIG. 1;

FIG. 23 is a perspective view showing components of another two-piece alternative configuration of the cosmetics applicator of FIG. 1;

FIG. 24 is a perspective view showing the cosmetics applicator of FIG. 23 in an assembled condition;

FIGS. 25, 26, 27, and 28, are perspective views as in FIG. 5, showing different alternative configurations of the cosmetics applicator of FIG. 1;

FIG. 29 is a perspective view showing components of another alternative configuration of the cosmetics applicator of FIG. 1;

FIG. 30 is a perspective view of the cosmetics applicator of FIG. 29 in a partially assembled condition and showing additional components thereof;

FIG. 31 is a perspective view of the cosmetics applicator of FIG. 29 in a fully assembled condition;

FIG. 32 is a perspective view showing components of another alternative configuration of the cosmetics applicator of FIG. 1, in a partially folded condition;

FIG. 33 is a perspective view of the cosmetics applicator of FIG. 32 in a fully folded and partially assembled condition;

FIG. 34 is a perspective view of the cosmetics applicator of FIG. 32 in a fully assembled condition;

FIG. 35 is a perspective view showing components of a different alternative configuration of the cosmetics applicator of FIG. 1, in a partially folded condition;

FIG. 36 is a perspective view of the cosmetics applicator of FIG. 35 assembled in the partially folded condition;

FIG. 37 is a perspective view of the cosmetics applicator of FIG. 35 in a fully folded condition;

FIG. 38 is a perspective view showing components of yet another alternative configuration of the cosmetics applicator of FIG. 1, in a partially folded condition;

FIG. 39 is a perspective view of the cosmetics applicator of FIG. 38 assembled in the partially folded condition;

FIG. 40 is a perspective view of the cosmetics applicator of FIG. 38 in a fully folded condition;

FIG. 41 is a perspective view showing an alternative configuration of the cosmetics applicator of FIG. 1, having wall formations of irregular height;

FIG. 42 is a sectional view of the cosmetics applicator of FIG. 41 on line 42-42 thereof;

FIG. 43 is a graph showing relative amounts of cosmetics applied to the subject's lips from the pattern of FIG. 9AA;

FIG. 44 is a graph showing relative amounts of cosmetics applied to the subject's lips from the pattern of FIG. 9BB;

FIG. 45 is a graph showing relative amounts of cosmetics applied to the subject's lips from the pattern of FIG. 9CC; and

FIG. 46 is a graph showing relative amounts of cosmetics applied to the subject's lips from the pattern of FIG. 9DD;

### DESCRIPTION OF EXEMPLARY AND PREFERRED EMBODIMENTS

The present invention is directed to a multi-pattern lip cosmetics applicator that facilitates forming a wide variety of artistic expressions, based on the chemical nature of lip cosmetic formulations that mix easily to allow smooth transitions among different colors and textures. The invention has been developed based upon six surprising findings. The first is that rubbing the lips against small-delimited cells containing different lip cosmetic compounds results in a mixture of those compounds being transferred to the lips. Secondly, assembling several small-delimited surfaces in bands, wider bands transfer greater amounts of particular compounds to the user's lips. The third finding is that, over a lip that already has a coat of lip cosmetic compound, mixing still take place with different lip cosmetic compounds from the small-delimited surfaces used as described above. The fourth finding is that the wall-like projections have a squeegee effect which limits the quantity of lip cosmetics that transfer to the lips every time the user moves the applicator against the lips, keeping the layer transferred uniformly without lumps. The fifth finding is that the wall-like projections, by limiting the quantity of lip cosmetic compounds that pass through, create an area where different lip cosmetics, which were hold back, do mix during the application process. The sixth finding is that the addition of irregular surfaces with valleys and raised projections on the top of wall-like projections enhance the mixing effect of different lip cosmetics during the application process.

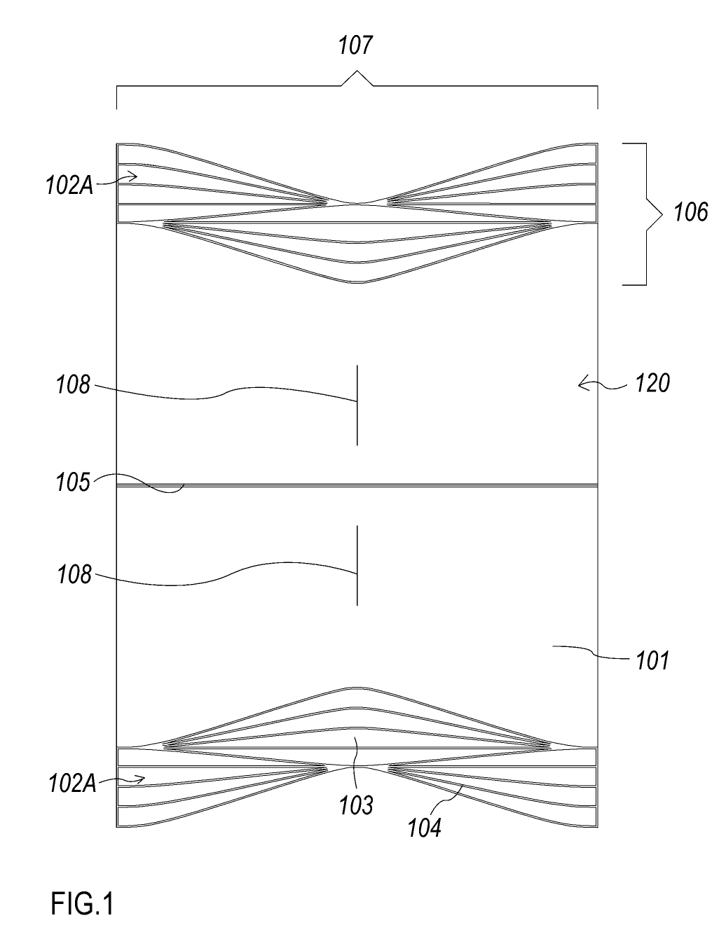

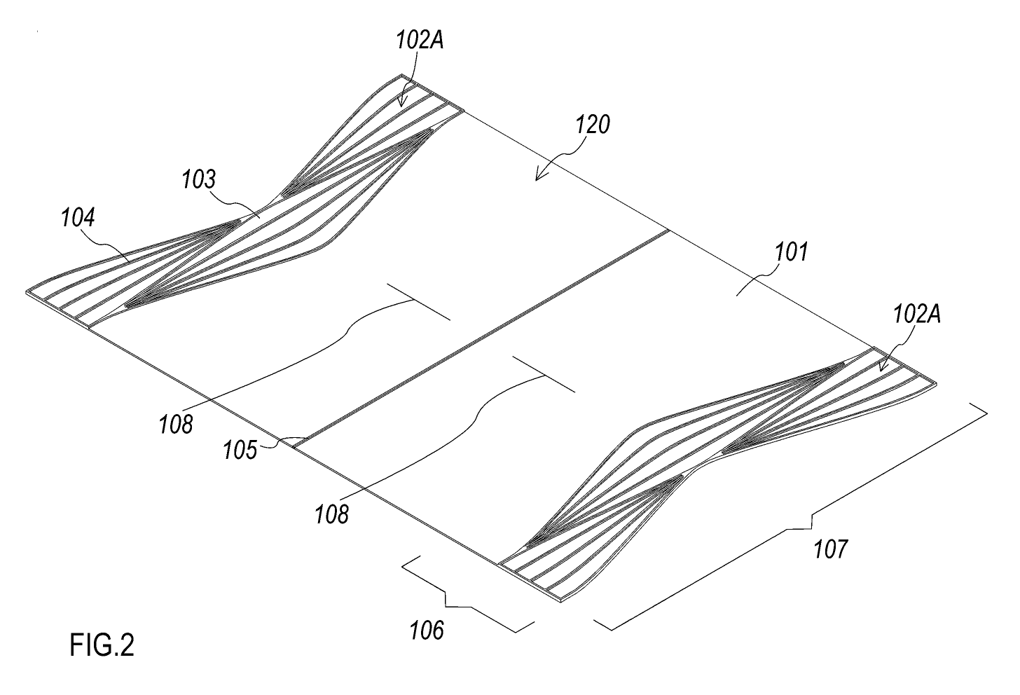

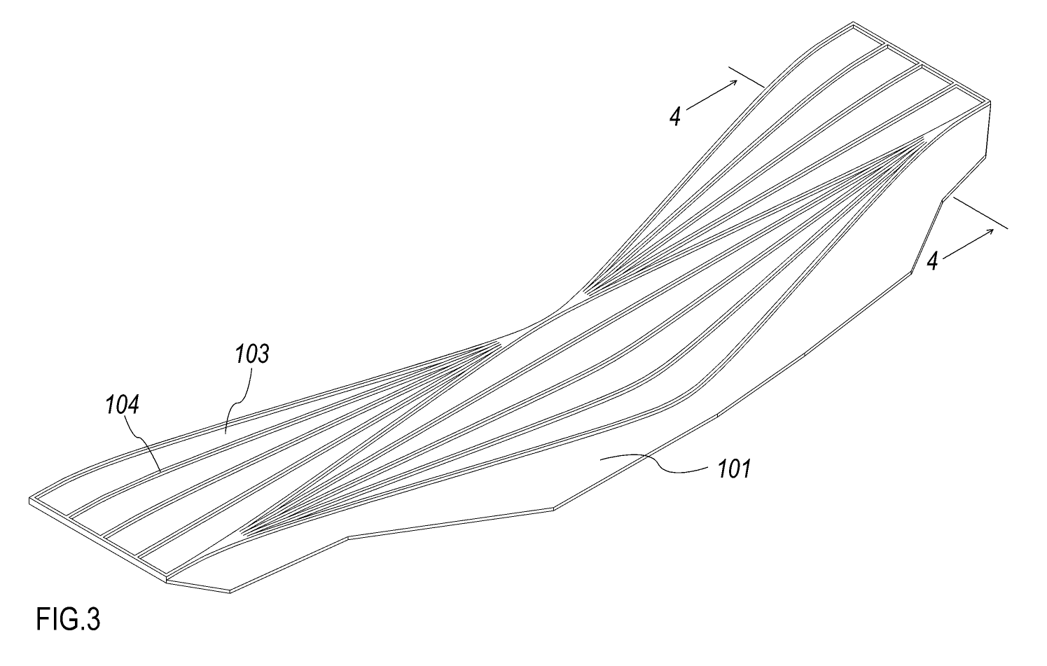

With reference to FIGS. 1-8, 9AA-9DD, and 9A-9D, an exemplary and preferred multi-pattern lip cosmetics applicator includes a thin base support 101 of a substantially uniform cross section made of any material that can hold its form under manipulation, impervious to the absorption of waxes and oils from lip cosmetic formulations, including but not limited to singly or in combination of materials like any plastic like material, polyethylene, polypropylene, vinyl, nylon, rubber, Teslin, Saran, open cell foam, closed cell foam, ferrous and no-ferrous metal foils, alloys, composites, various plasticized materials, etc.

The base support 101 has a face surface 120 with two primary regions 102A, a substantially flat back surface 121 on the flip side. A hinge 105 divides the base support 101 in two parts, each one having one of the primary regions 102A.

Wall-like projections 104 rise from the base support 101, having a height ranging from about 0.6 mils to about 11 mils, for dividing the primary region 102A in a multitude of small-delimited cells 103. Several methods can be used to form the wall-like projections 104 such as mechanical embossing, reverse embossing, slitting, molding, laminating, printing, vacuum-forming, etc. Each primary region 102A has a length 106 and a width 107. A mid-line indicator 108 is aligned midway across the width 107.

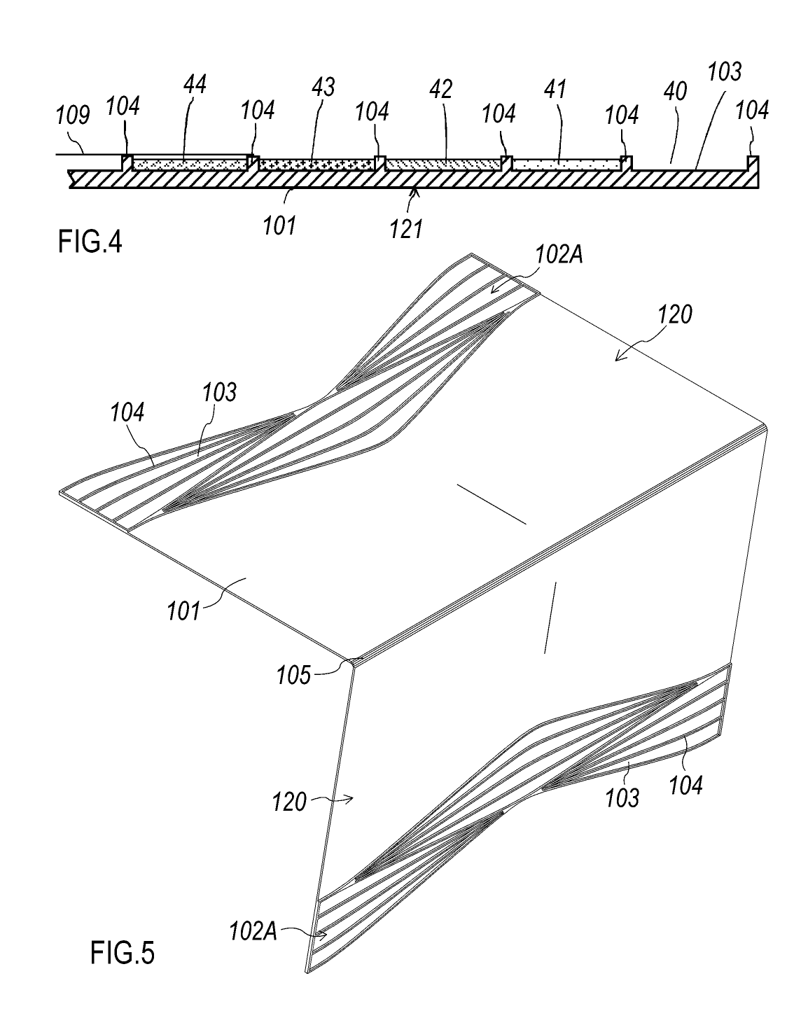

FIG. 4 shows a diagrammatic view in cross-section of the primary region 102A with the wall-like projections 104 that define the small delimited cells 103 that are coated with different lip cosmetics 41, 42, 43 and 44. The coatings of lip cosmetics may be deposited in any convenient thickness, preferably ranging from about 0.5 mils to about 11 mils, adequate to satisfy a typical user or subject. It will be understood that “user” and “subject” refer to one holding the applicator and one whose lips receive the cosmetics as shown in FIG. 8, and that they can be the same or different people. FIG. 4 further shows one small-delimited cell 103 having no lip cosmetic coat, designated 40. Accordingly, the wall-like projections 104 should extend only slightly above the thickness of the transferable lip cosmetic coats. Preferably the projections 104 extend substantially the full width 107 of the primary region 102A. It will be understood, however, that particular ones of the projections can have individual segments that are staggered in the length direction while retaining a generally regular spacing of the projections in the length direction. The deposition of the cosmetics may be done by any conventional printing method, such as flexography, silk-screening, painting, bubble jet printing, gravure or otherwise deposited over selected sections and preferably followed by a heating treatment for melting the cosmetic to form a hardened surface.

FIG. 5 shows the applicator partially folded on its hinge 105 by approaching the back face 121 and leaving the face surface 120 with the primary regions 102A facing outwardly.

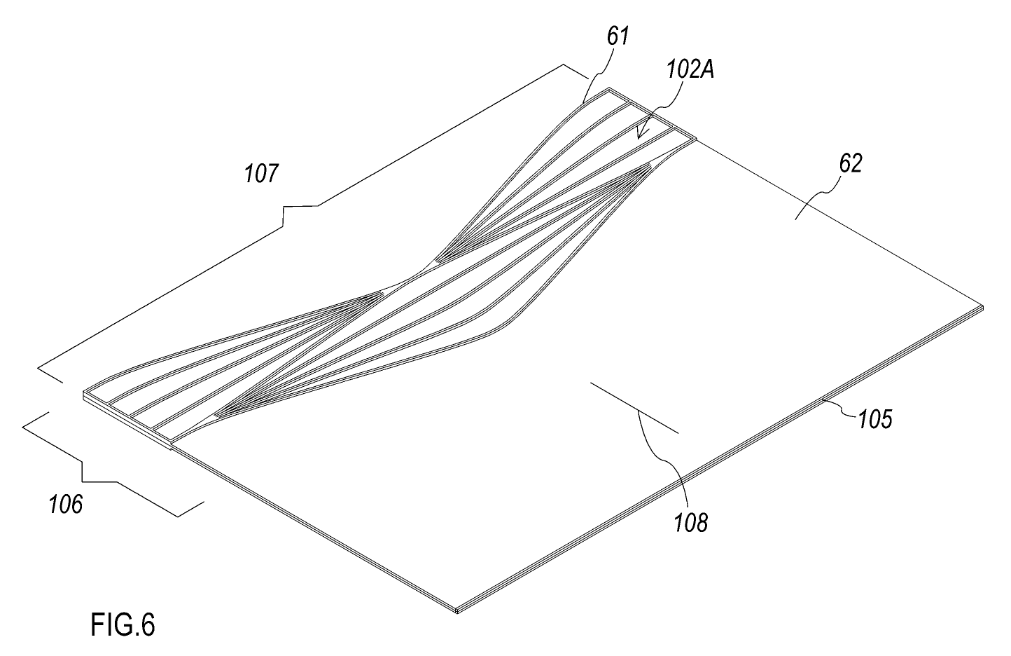

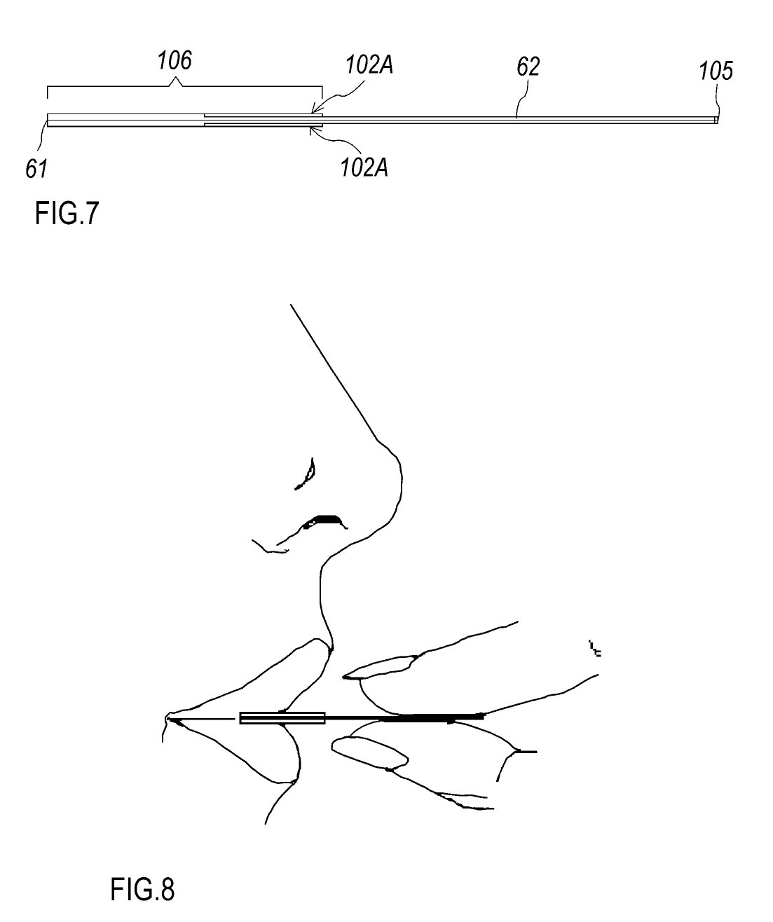

FIGS. 6 and 7 show the applicator fully folded. Portions of the applicator outside the primary regions function as a handle or holder 62. The edge of the applicator opposite from the holder 62 forms a leading edge 61 and is substantially parallel with the width 107.

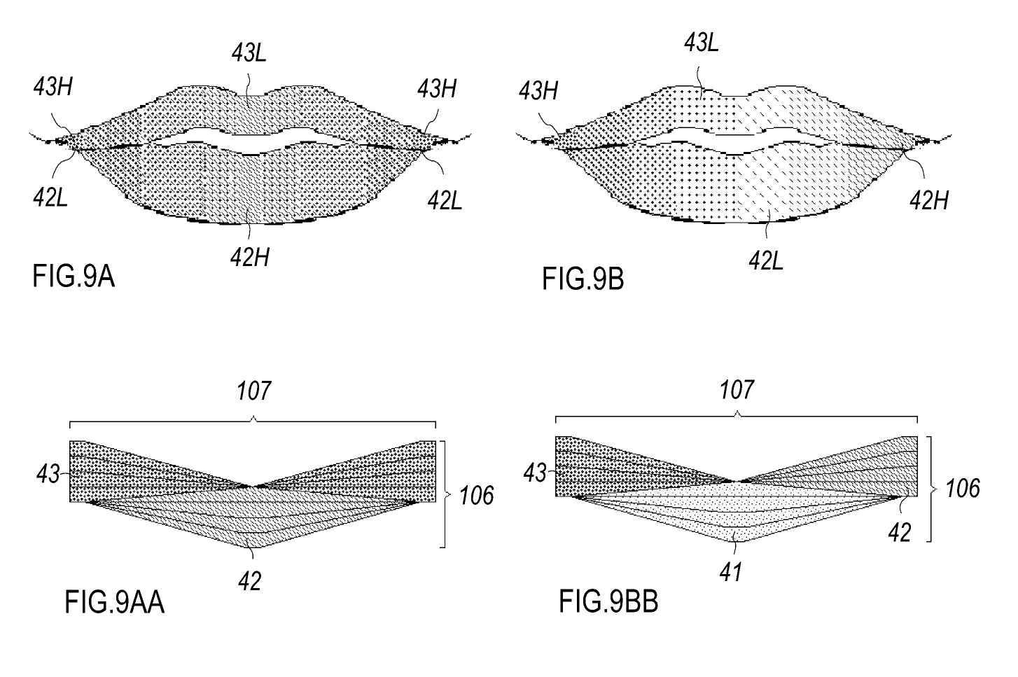

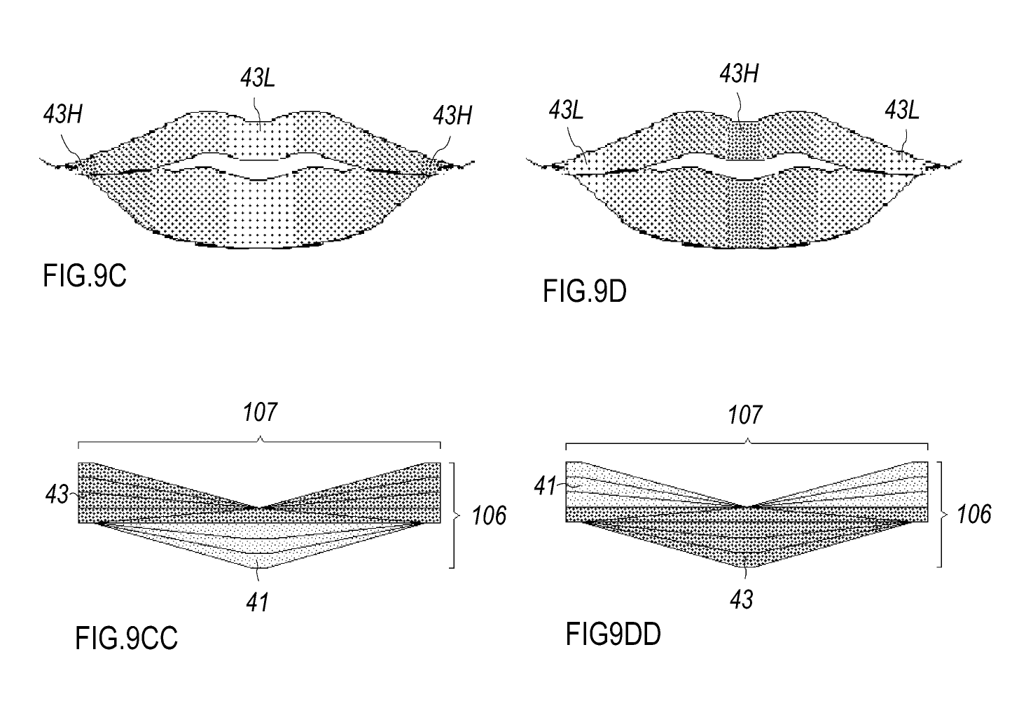

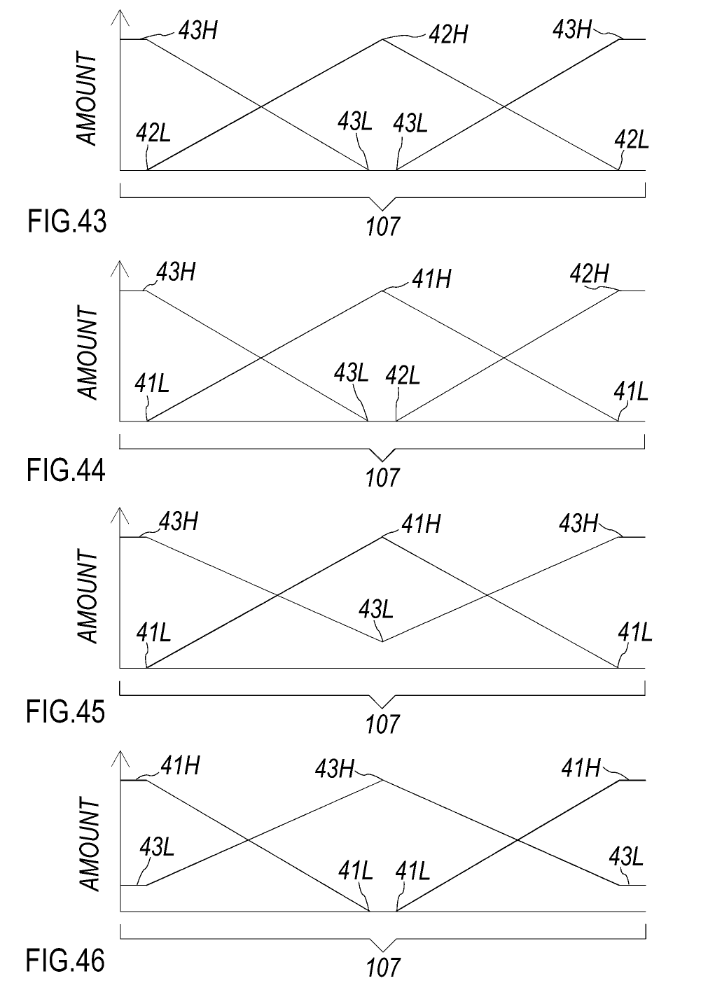

FIGS. 9AA to 9DD show samples of the face view of one primary region design having different patterns of lip cosmetic compounds 41, 42, 43 applied thereto. Small-delimited cells 103 having the same lip cosmetic composition adjacent to each form bands that run along the width 107. The design and pattern of lip cosmetic coatings in the primary region determine the design and pattern of lip cosmetics that will be transferred to the use's lips as shown, respectively, in FIGS. 9A to 9D. It will be understood that the resulting composition of cosmetic across the lips shown in FIGS. 9A to 9D gradually changes as indicated approximately by different fill patterns in those figures, and more clearly in FIGS. 43, 44, 45, and 46, which correspond to FIGS. 9AA and 9A, 9BB and 9B, 9CC and 9C, and 9DD and 9D, respectively.

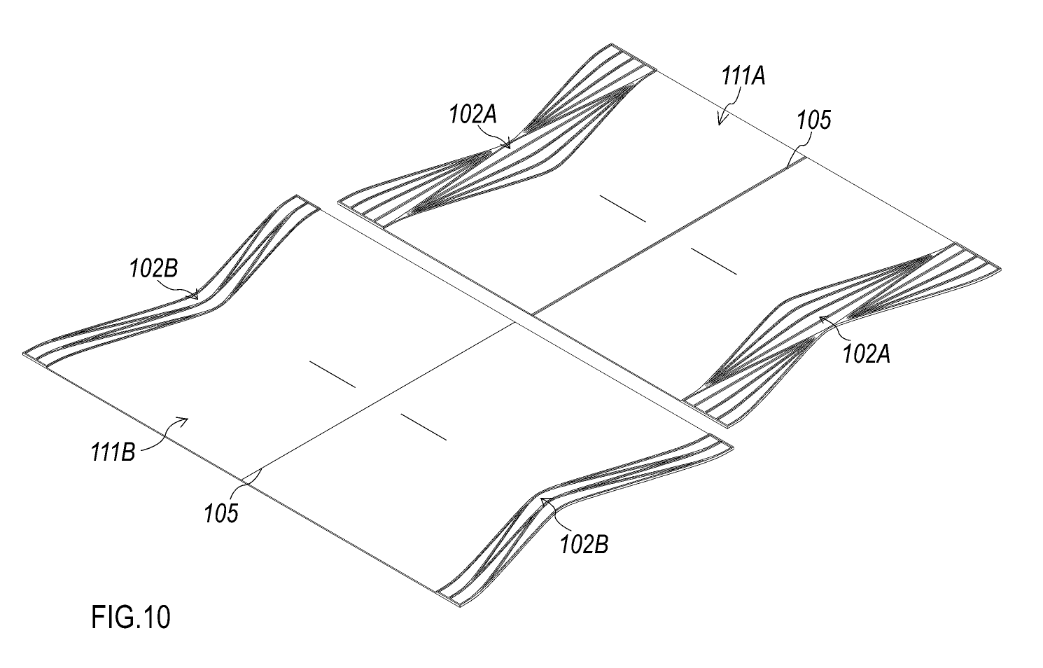

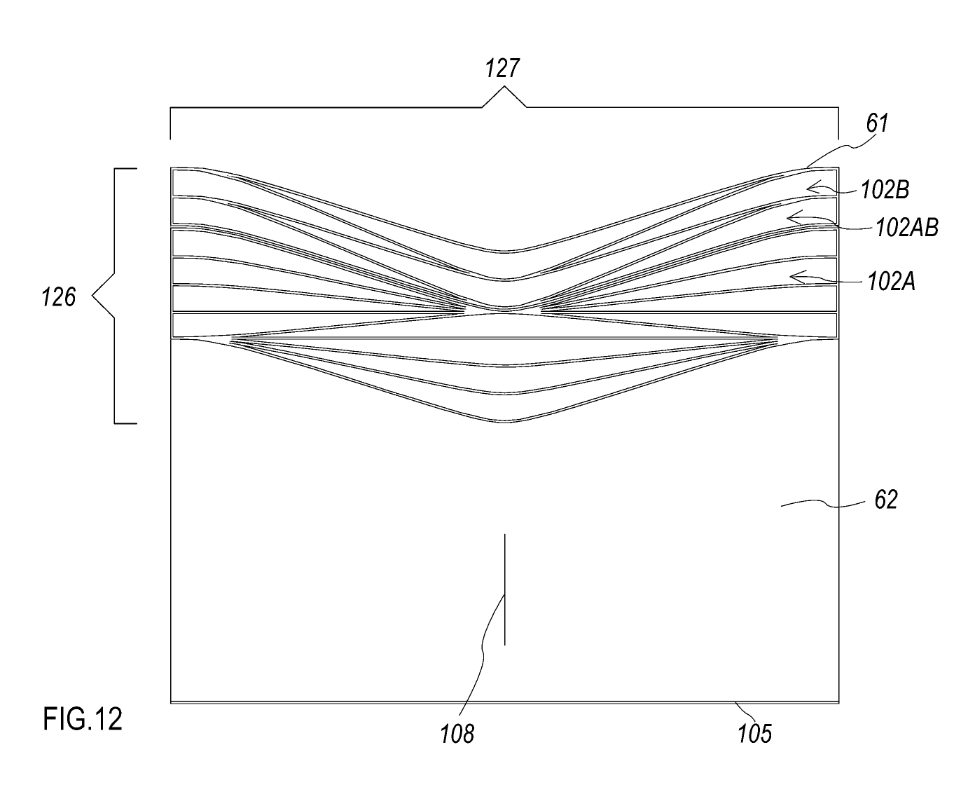

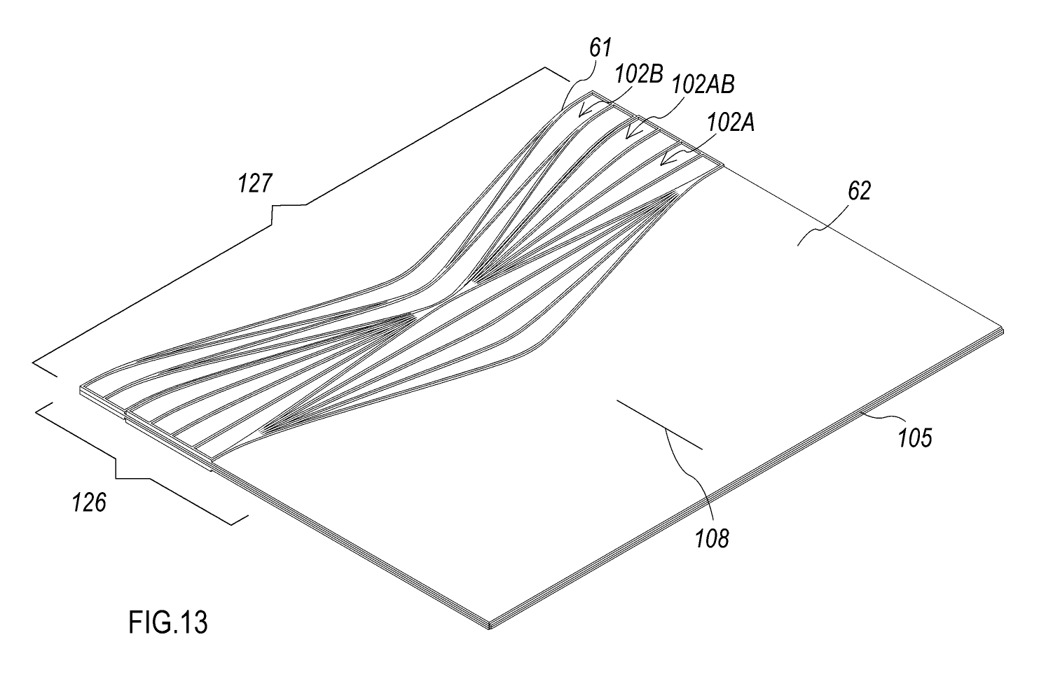

With further reference to FIGS. 10-13, an applicator 111A corresponding to the applicator of FIGS. 1-8 forms one component and another applicator 111B having a primary region 102B forms a second component of a two-component applicator. The applicator 111A has a full-length or multiple hinges 105 that allow the applicator 111A to envelop the folded applicator 111B, the primary region 102B extending exposed beyond the primary region 102A of the applicator as shown in FIGS. 12 and 13 and as further described below.

FIGS. 12 and 13 show face and perspective views of the applicator 111B enveloped by applicator 111A, which result in a combined primary region 102AB with a width 127 and a length 126. The combined applicator has a leading edge 61 and a holder 62.

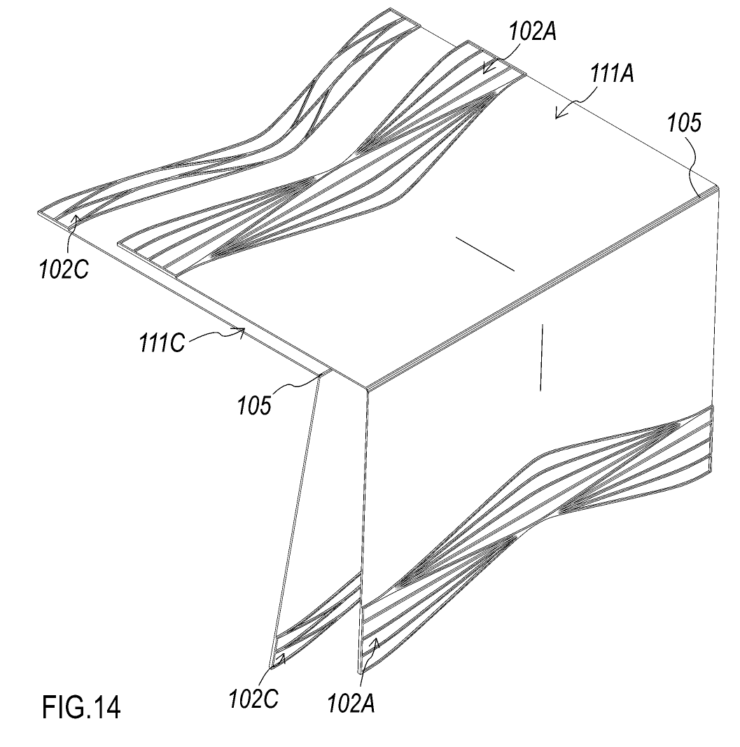

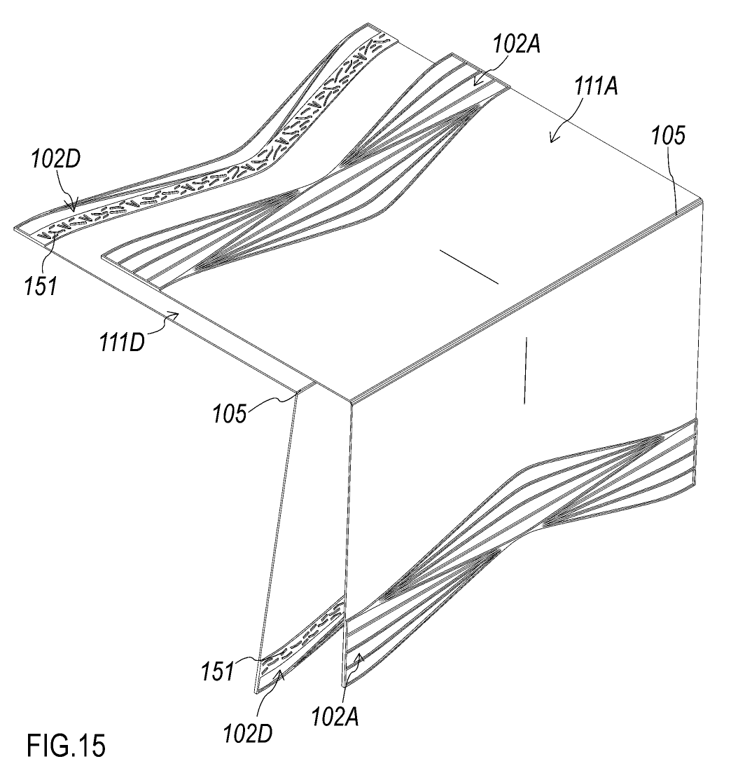

FIGS. 14 and 15 show perspective views of the same enveloping applicator 111A combined with different enveloped applicators 111C and 111D, each of them having different primary regions 102C and 102D respectively.

FIG. 15 also shows the primary region 102D having a band of irregular surface 151 that includes valleys and elevations.

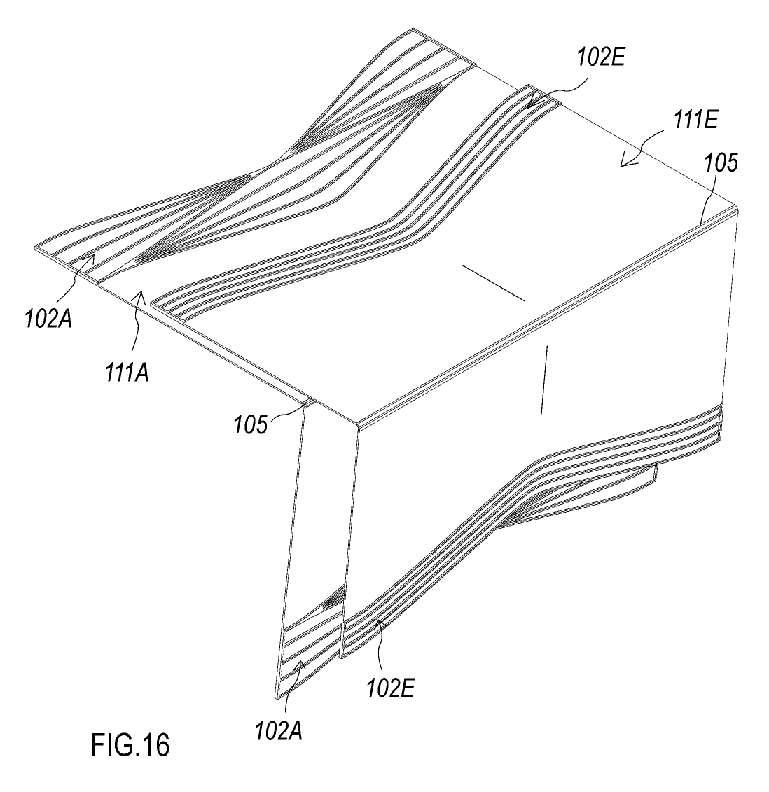

FIG. 16 shows an applicator 111E having a primary region 102E enveloping the applicator 111A, the primary region 102A extending beyond the primary region 102E.

FIGS. 10-16 show different primary region designs, each one may have different patterns of lip cosmetic coats such as those designated 41, 42, 43 and 44 in FIG. 4.

From the above description, it is noted that the primary region may have a multitude of different designs, and each one may have a multitude of different patterns of lip cosmetic compositions. Further, different combinations of primary region configurations of enveloping components multiplies the diversity of effects the user can choose from.

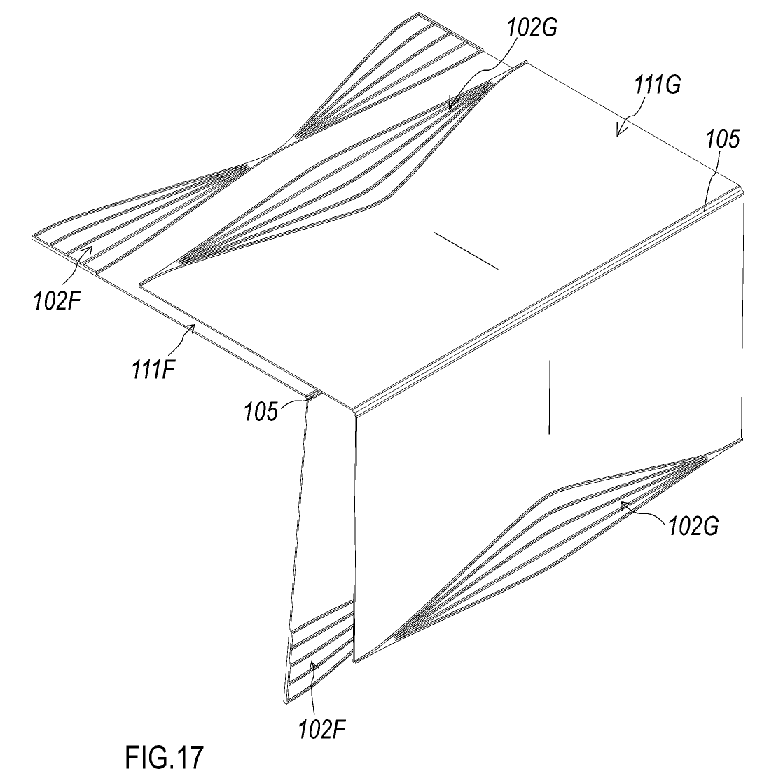

Additional embodiments are shown in FIG. 17 to 28. Each embodiment has different primary region that can have a multitude of different patterns of lip cosmetic compounds and as part of an enveloping system results in a multitude of different combinations of primary regions.

FIG. 17 shows an applicator system with two applicators designated 111F and 111G, having respective primary regions 102F and 102G that form a direct counterpart of the primary region 102A of the preferred configuration of FIG. 1 and designated applicator 111A in FIG. 10 to FIG. 16. Each applicator has at least one lip cosmetic compound on its primary region.

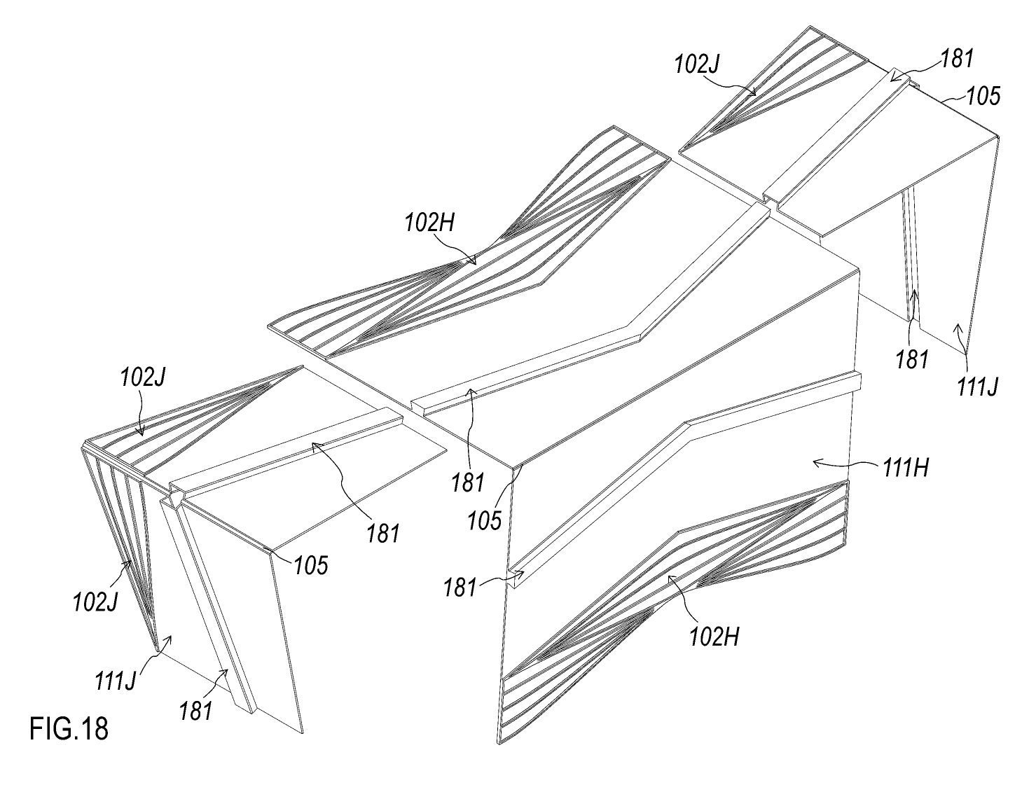

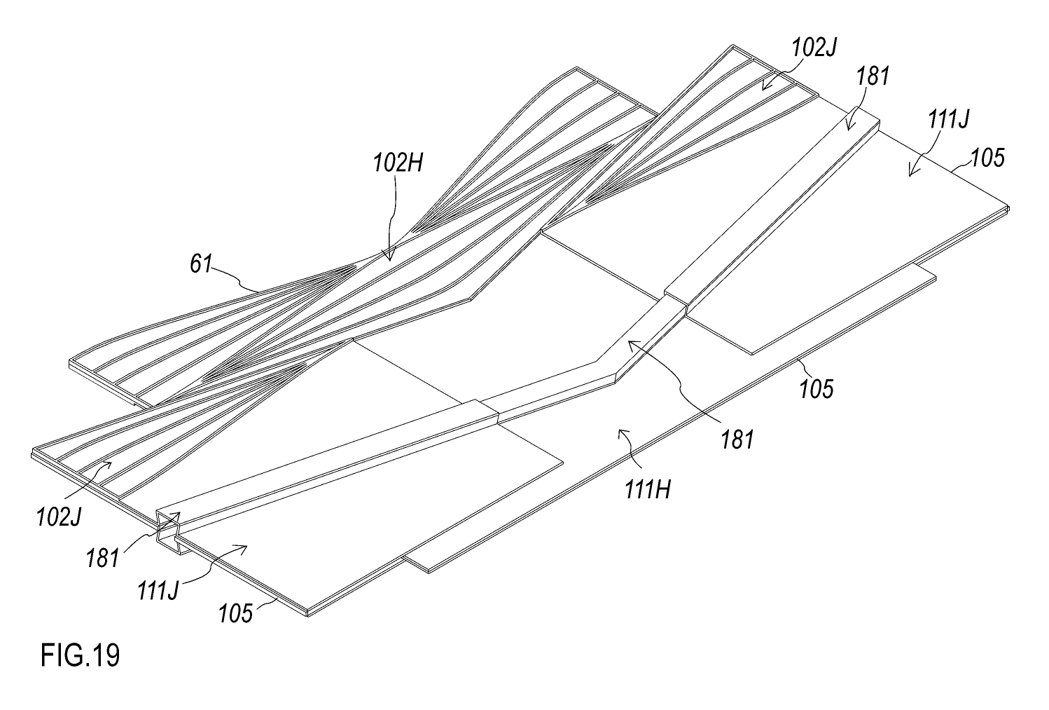

FIGS. 18 and 19 show an applicator system including a central applicator 111H and a laterally movable pair of side applicators 111J. These applicators incorporate a track system 181 including creases and folds that form a central channel for guiding the applicators 111J relative to the applicator 111H in sliding engagement. The user slides the applicators 111J along the track to desired position that normally are symmetrical relative to the applicator 111H.

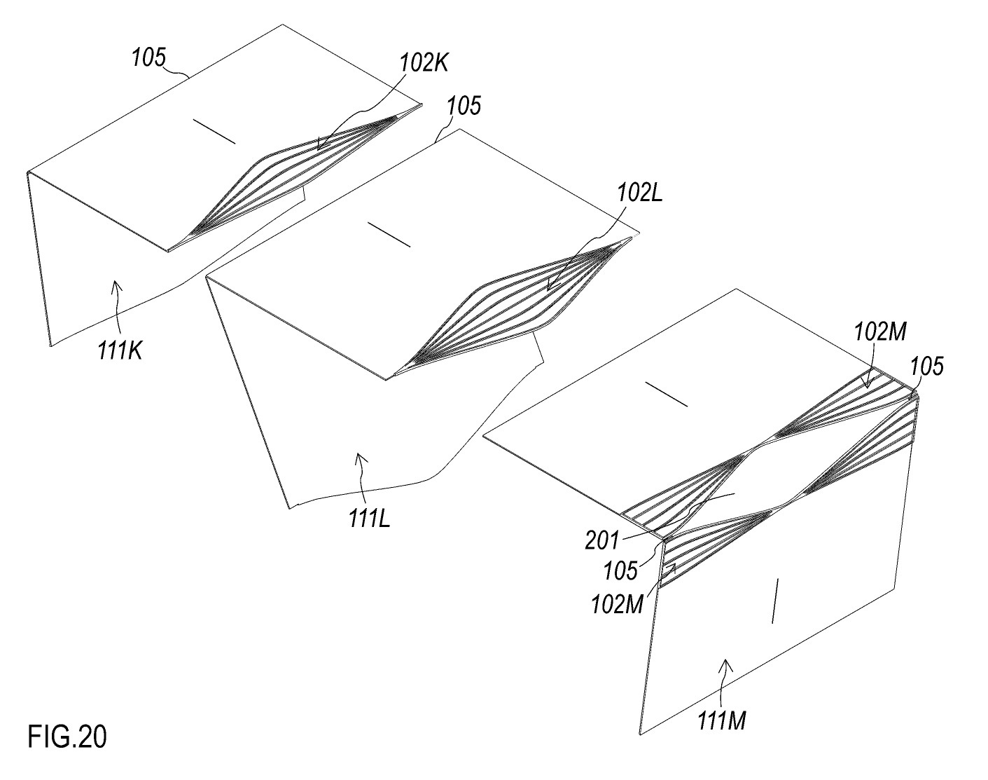

FIGS. 20 and 21 show a system of three applicators, wherein an applicator 111M has an aperture 201 that allows a primary region 102L of an applicator 111L to be exposed therethrough as shown in FIG. 21. Another applicator, designated 111K and having a primary region 102K, is configured for enveloping one or both of the other applicators with the primary region(s) 102L and/or 102M projecting beyond the region 102K. In this embodiment, the user may combine only two applicators, 111M with 111L or 111M with 111K, all three applicators, or any one of the applicators.

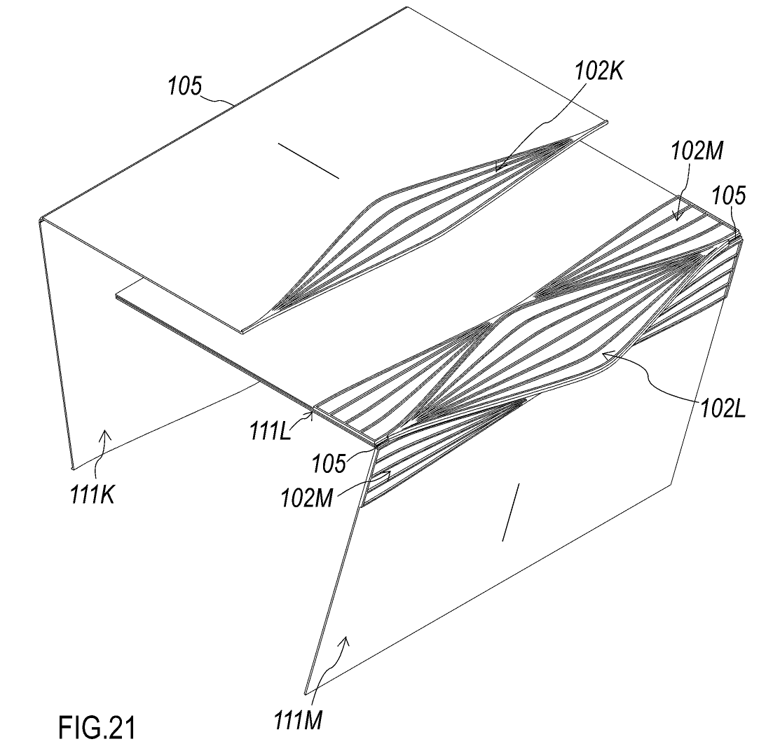

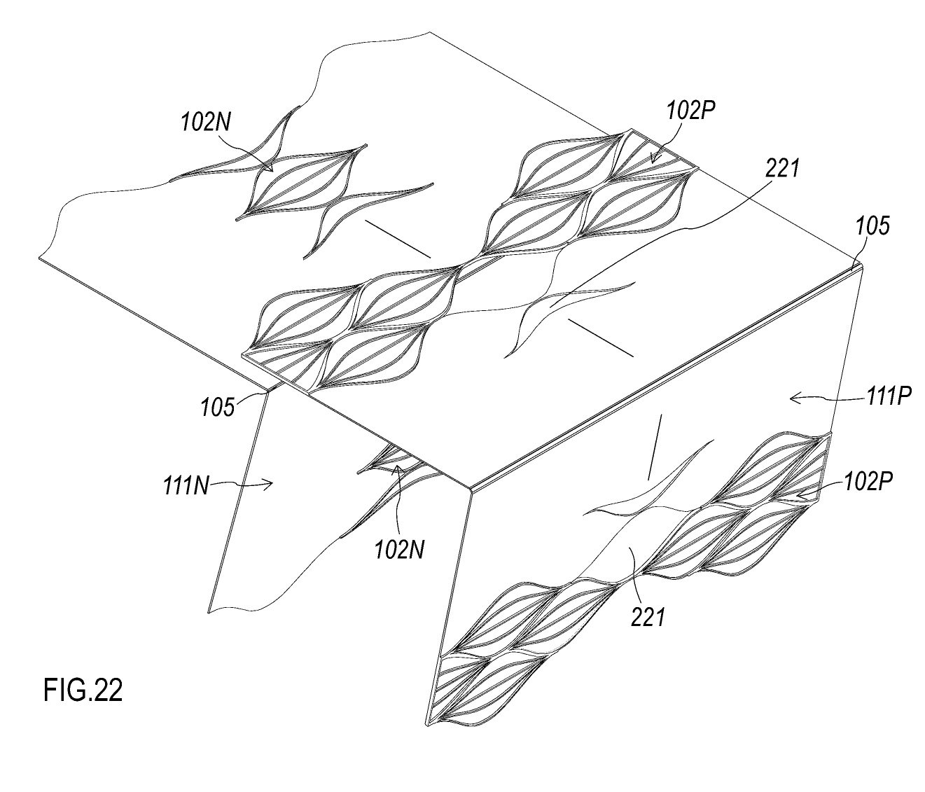

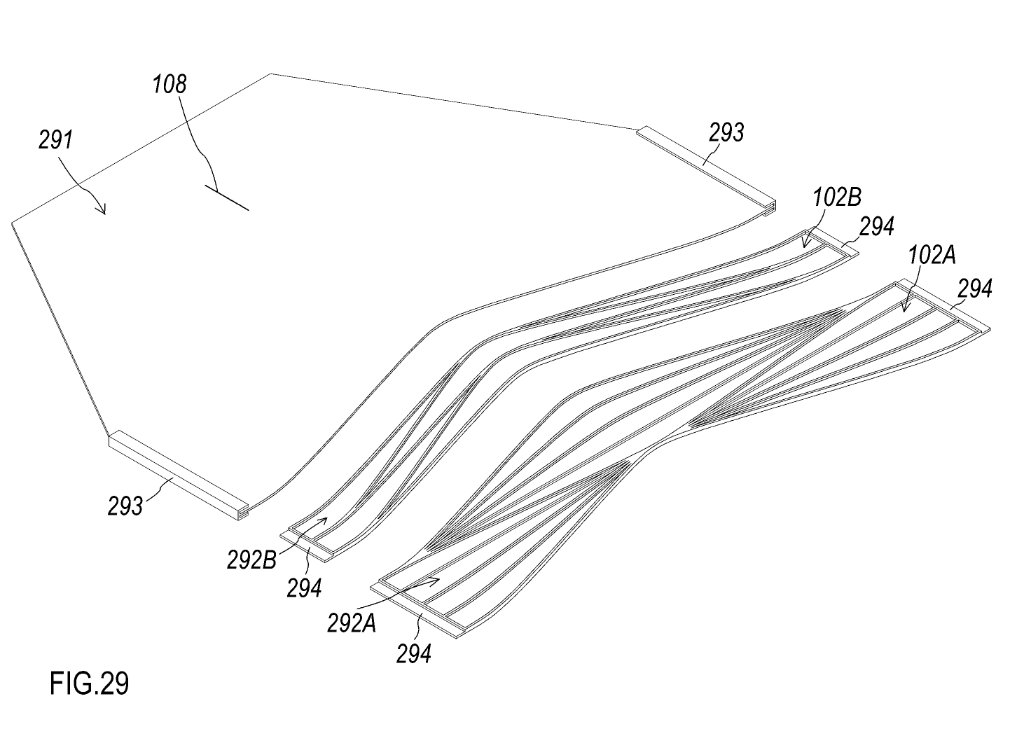

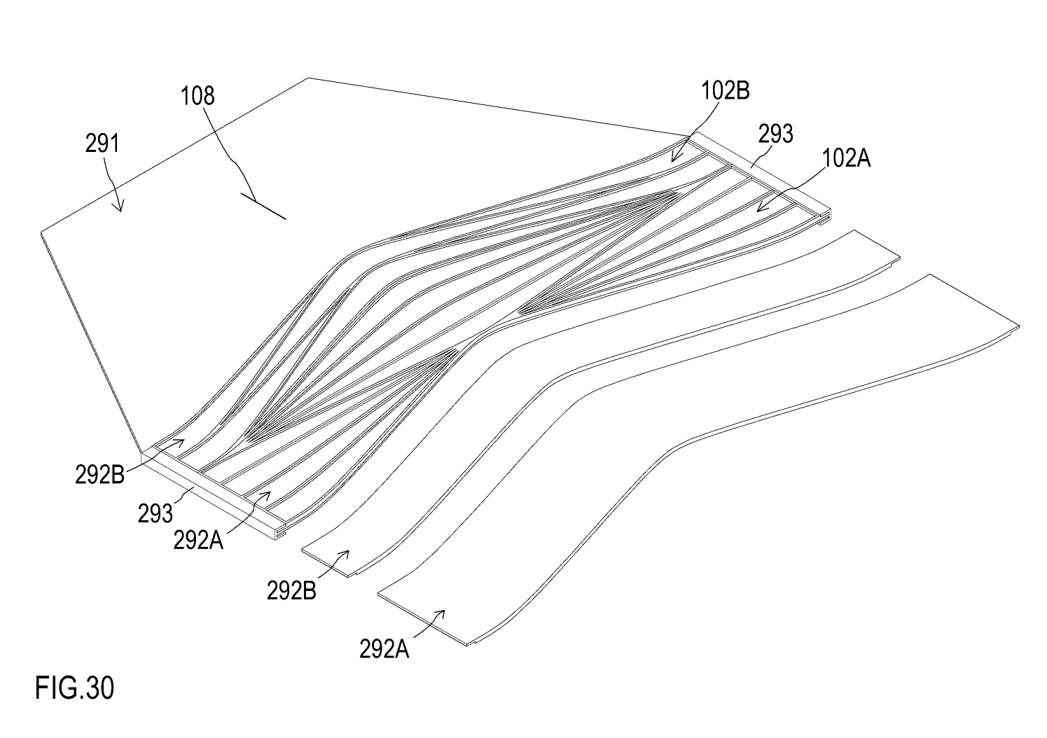

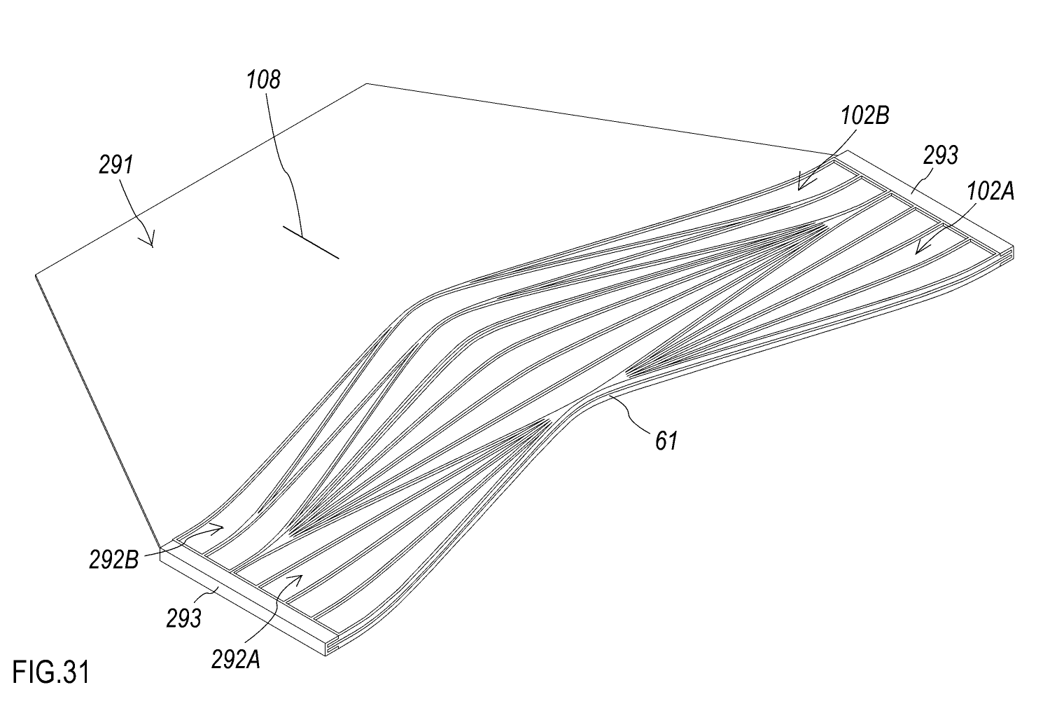

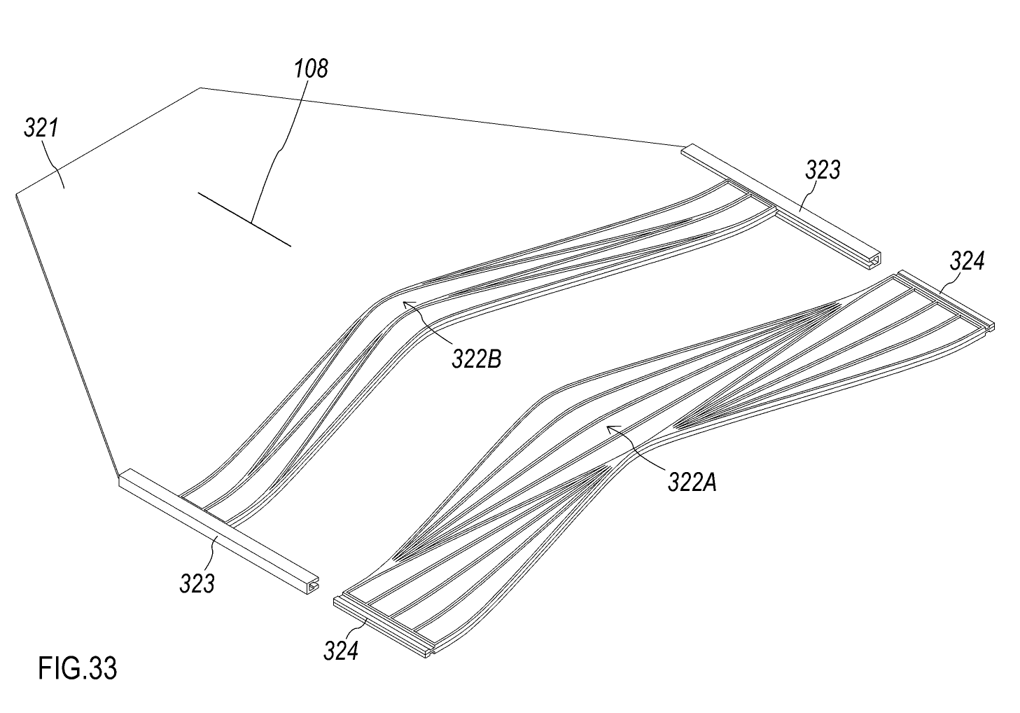

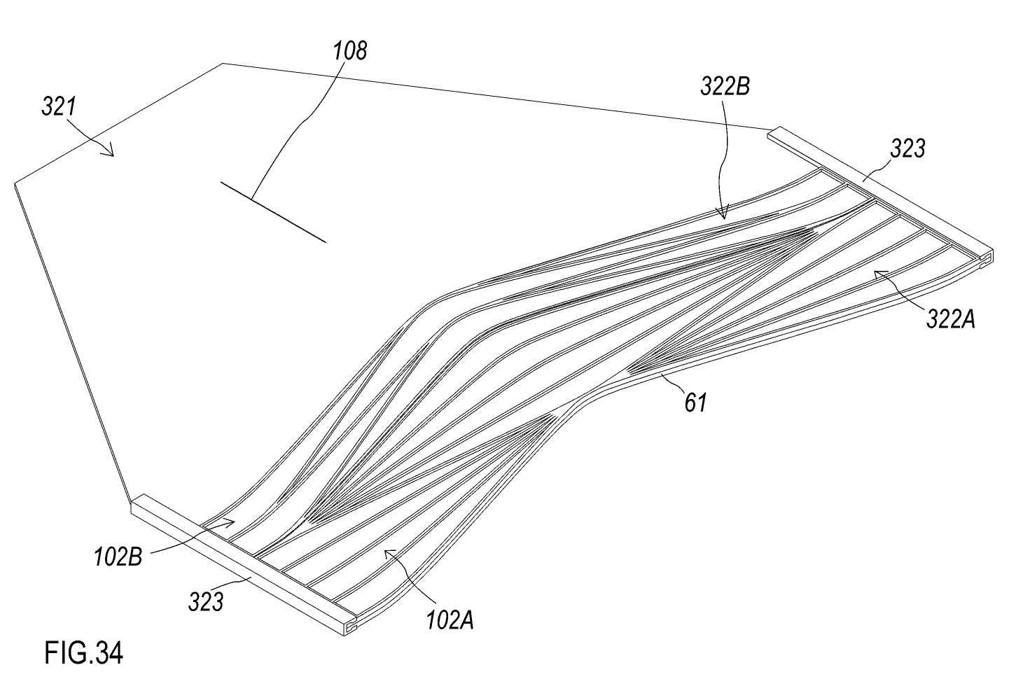

FIG. 22 shows an applicator 111P having primary regions 102P at opposite extremities, and respective apertures 221. The applicator 111P encloses another applicator, designated 111N such that portions of a primary region 102N thereof is exposed through each of the apertures. More particularly, one portion of the primary region 102N projects beyond the primary region 102P, while other portions of the region 102N are exposed through corresponding parts of the matching aperture 221. It will be understood that composite primary regions are formed by the various combinations of applicators shown and described above in connection with FIGS. 10-22, and in connection with FIGS. 29-34 as further described below.

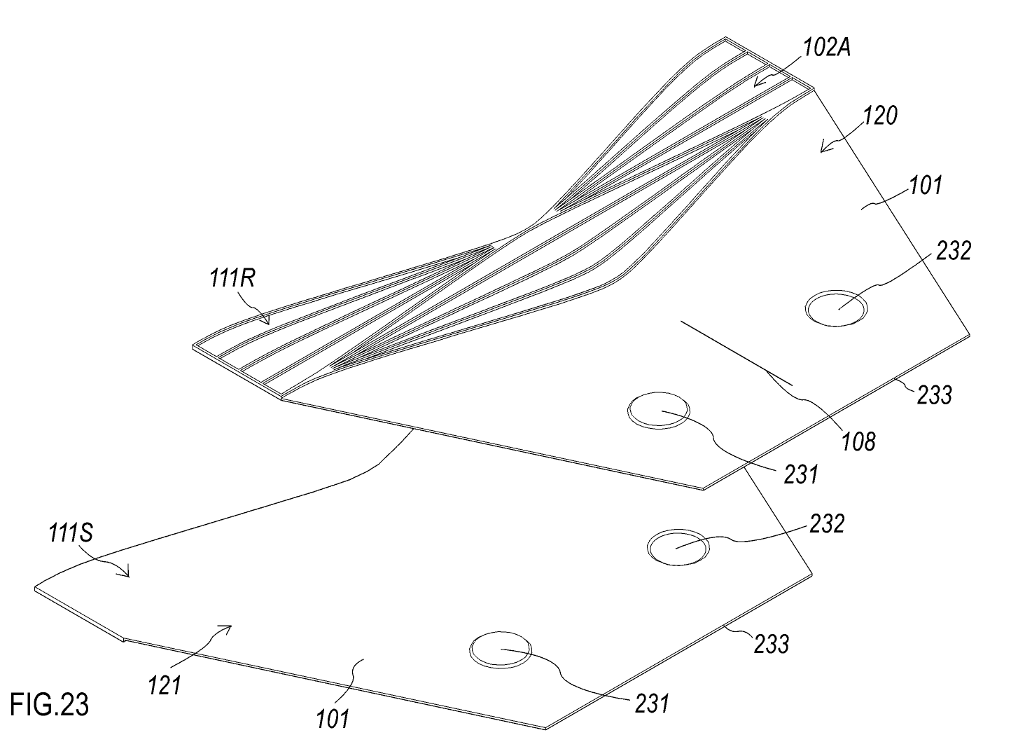

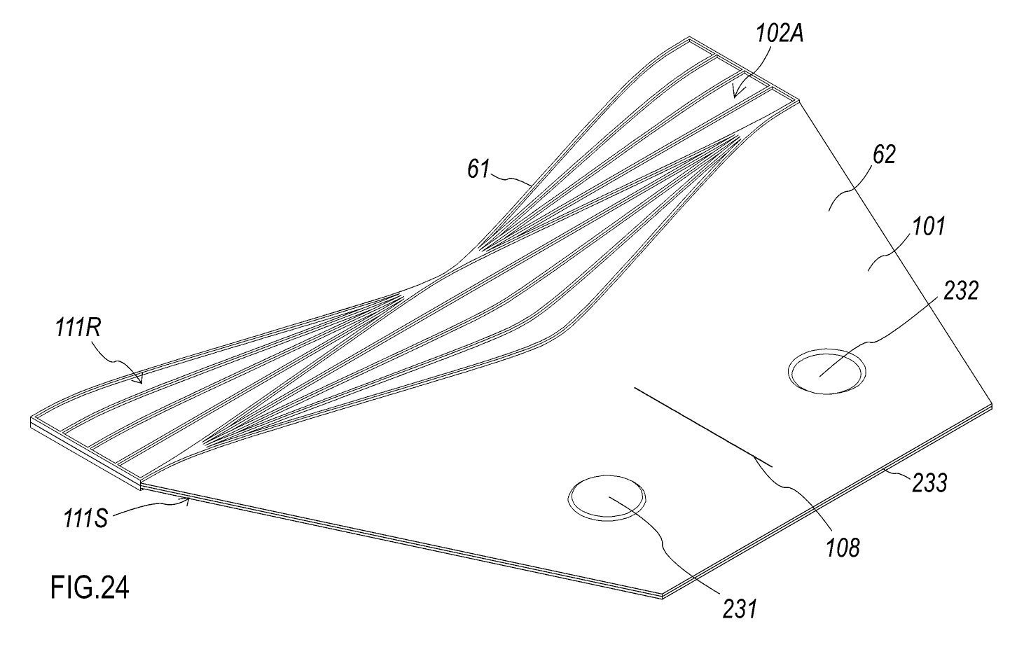

FIGS. 23 and 24 show an applicator not having a hinge such as the hinge 105 shown in FIG. 1, for example, the applicator having separate applicator components 111R and 111S, including respective base supports 101, each of the supports having a counterpart of the primary region 102A. Two pair of substantially frustro-conical projections 231 provide registration of the base supports. In the exemplary configuration shown in the drawings, one of the projections 231 being located on a face surface 120 of the applicator component 111R and another on a back surface 121 of the applicator component 111S, each one positioned in opposite side and equal distance from the midline indicator 108 and equal distance from a corresponding rear edge 233. Each projection 231 forms complementary opening or depression 232, the depressions 232 of the remaining projections being formed on the face surface 120 of the applicator component 111R and on the back surface 121 of the applicator component 111S. Nesting engagement of the projections 231 with corresponding depressions 232 allows an interlocking tight fit, thereby holding the components 111R and 111S together back-to-back and in registration. It will be understood that the user can combine two applicators having the same or different primary region configurations.

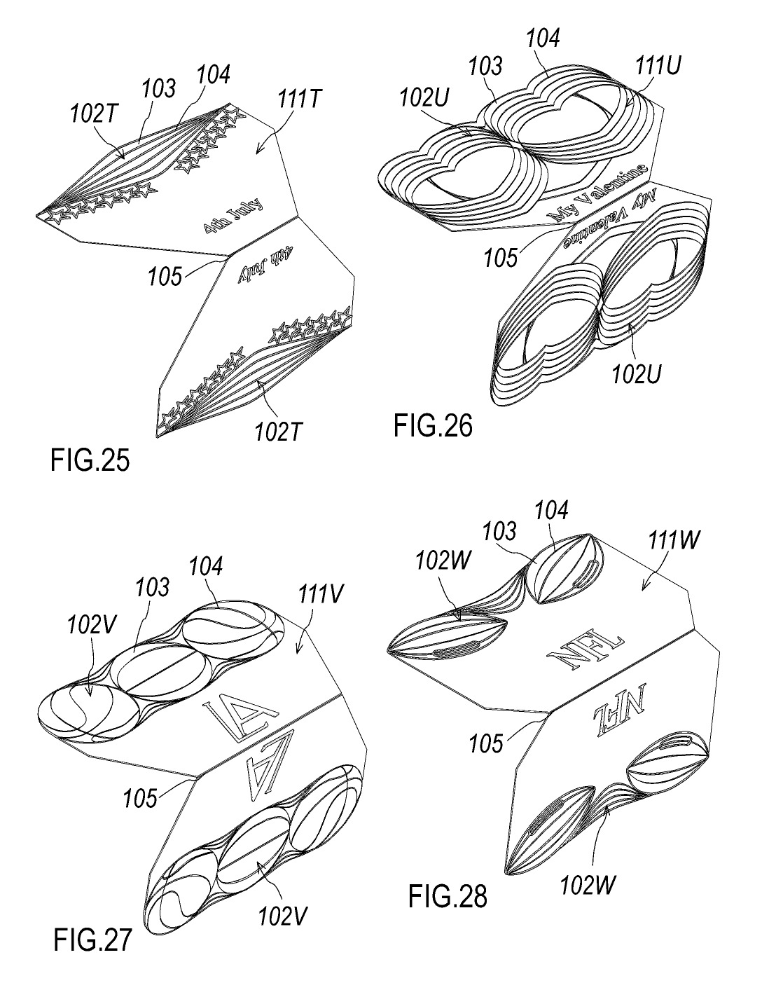

With further reference to FIGS. 25-28, additional cosmetic applicators having primary regions that form recognizable patterns related to different themes and occasions are contemplated. For example, an applicator 111T having primary regions 102T in a “4of July” design is shown in FIG. 25; FIG. 26 shows an applicator 111U having primary regions 102U forming a “My Valentine” design; FIG. 27 shows an applicator 111V having primary regions 102V in a basketball design; and FIG. 28 shows an applicator 111W having primary regions 102W in a football design. Each applicator may be used alone or as part of enveloping system.

FIGS. 29-31 show a system including applicator cards 292A and 292B, each having counterparts of the primary regions 102A and 102B, respectively. The applicator cards have projections 294 that slide on channel elements 293 on both surfaces of a handle 291 and form a counterpart of the leading edge 61.

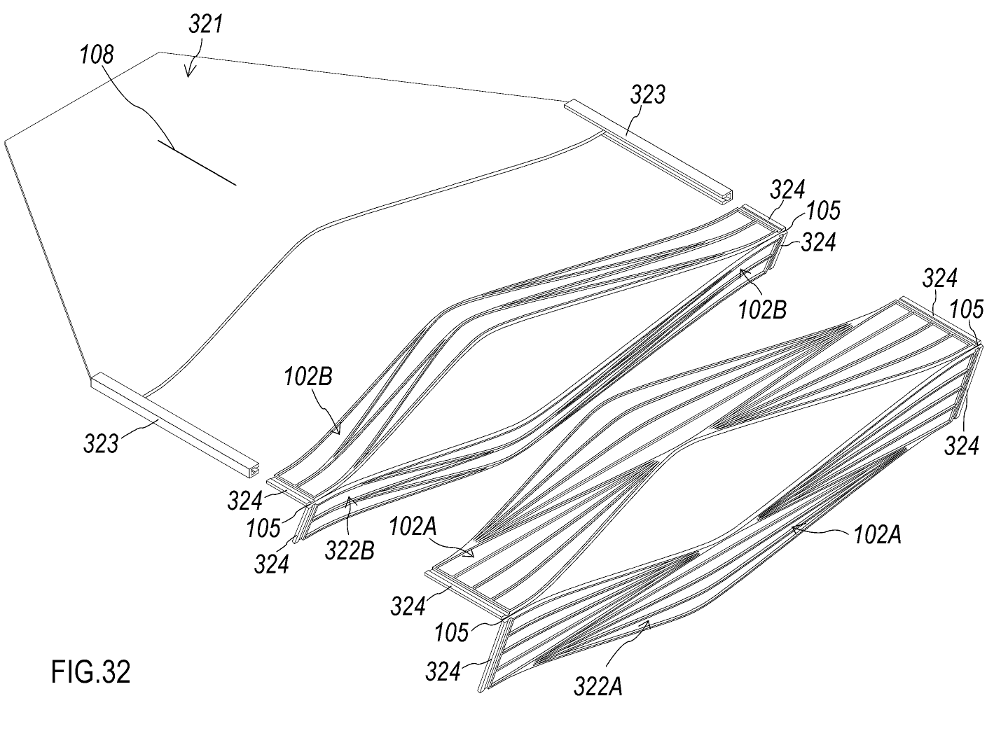

FIGS. 32-34 show a system including a handle element 321 and applicator cards 322A and 322B, each card having counterparts of the primary regions 102A and 102B, respectively, the primary regions being separated by a counterpart of the hinge element 105. The applicators have lateral projections 324 that engage in a rail and track relation with corresponding channel elements 323 of the handle 321 for allowing the applicator to slide and form a counterpart of the leading edge 61.

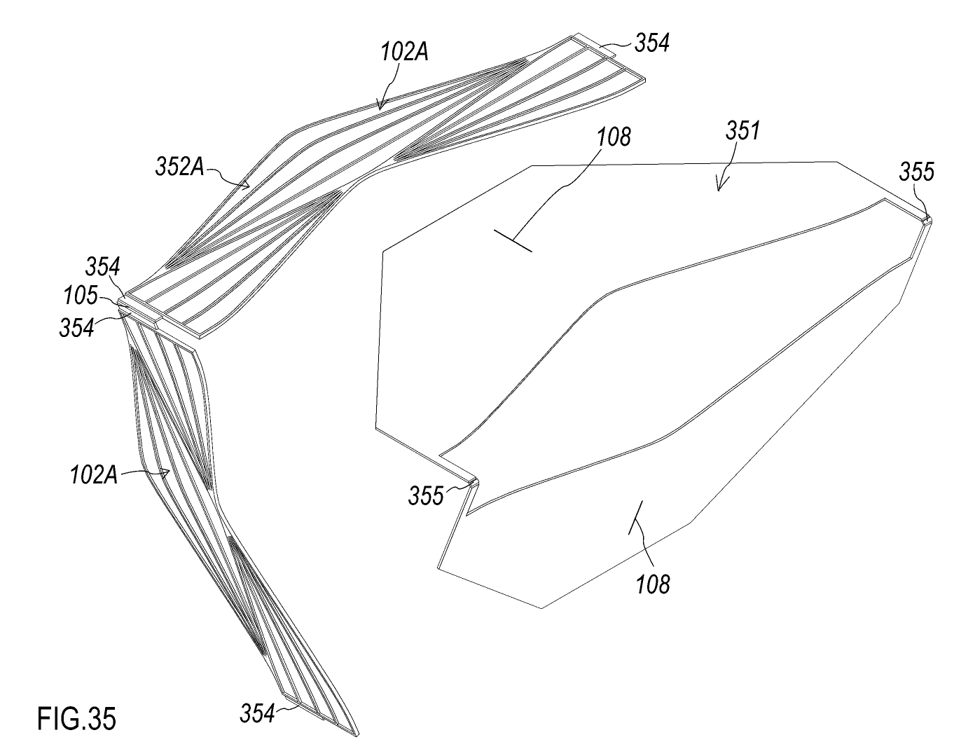

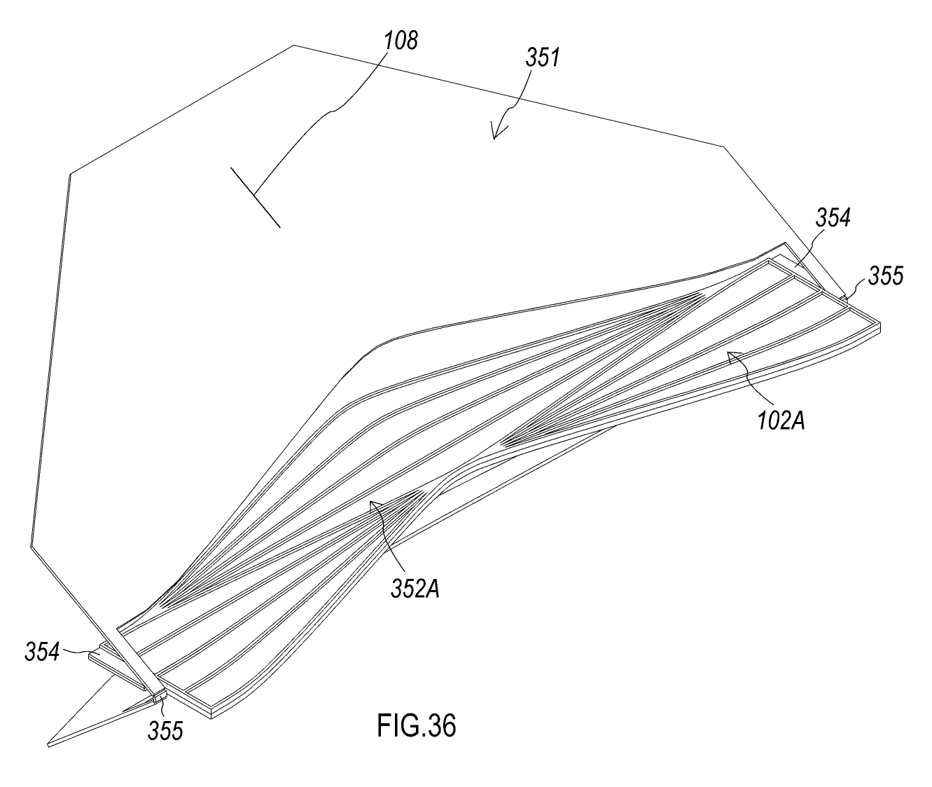

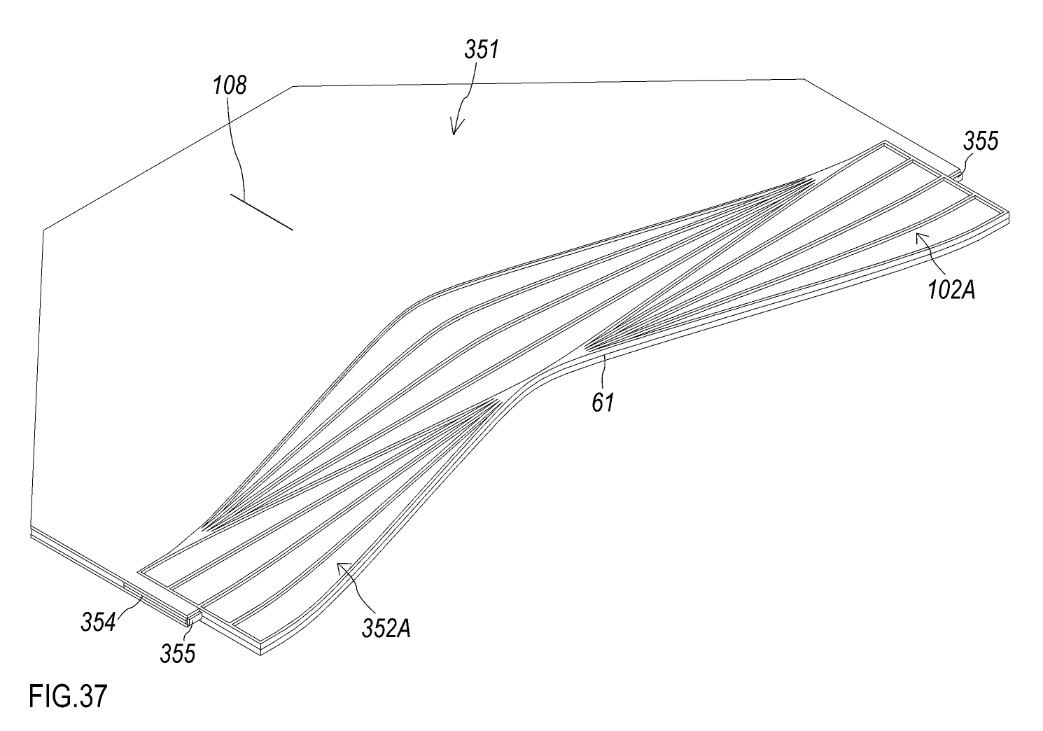

FIGS. 35-37 show a system including a handle 351 and an applicator card 352A having two counterparts of the primary region 102A separated by a counterpart of the hinge element 105, lateral projections 354 extending oppositely from each primary region 102A. The handle 351 includes a spaced pair of hinges 355 and envelopes the applicator card 352A with the projections 354 being located behind and engaging the handle hinges 355 for locking the card in position, the card being secured in a folded condition and forming a counterpart of the leading edge 61.

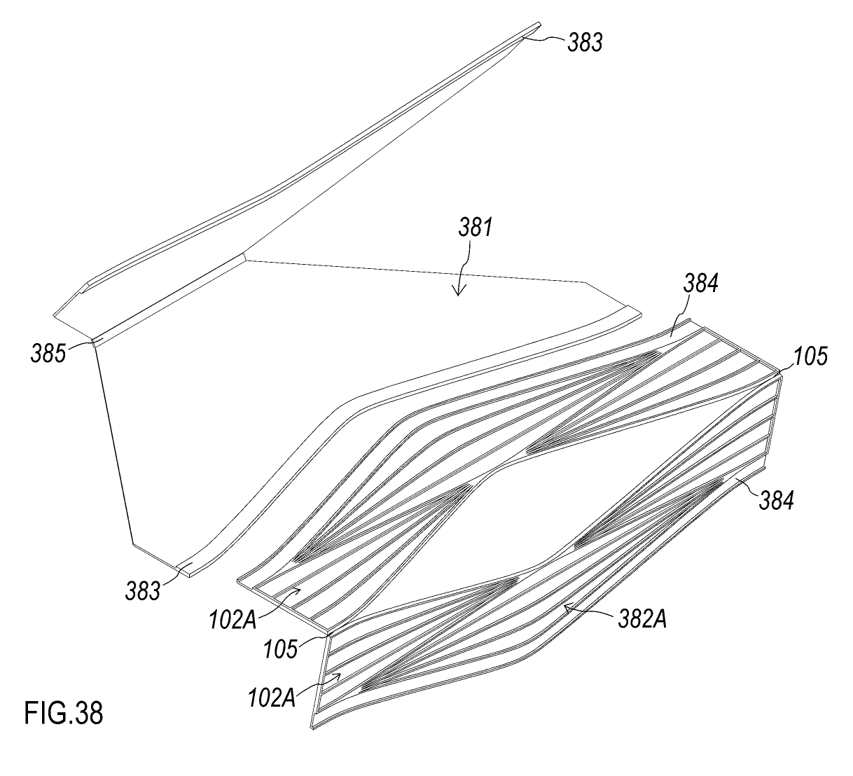

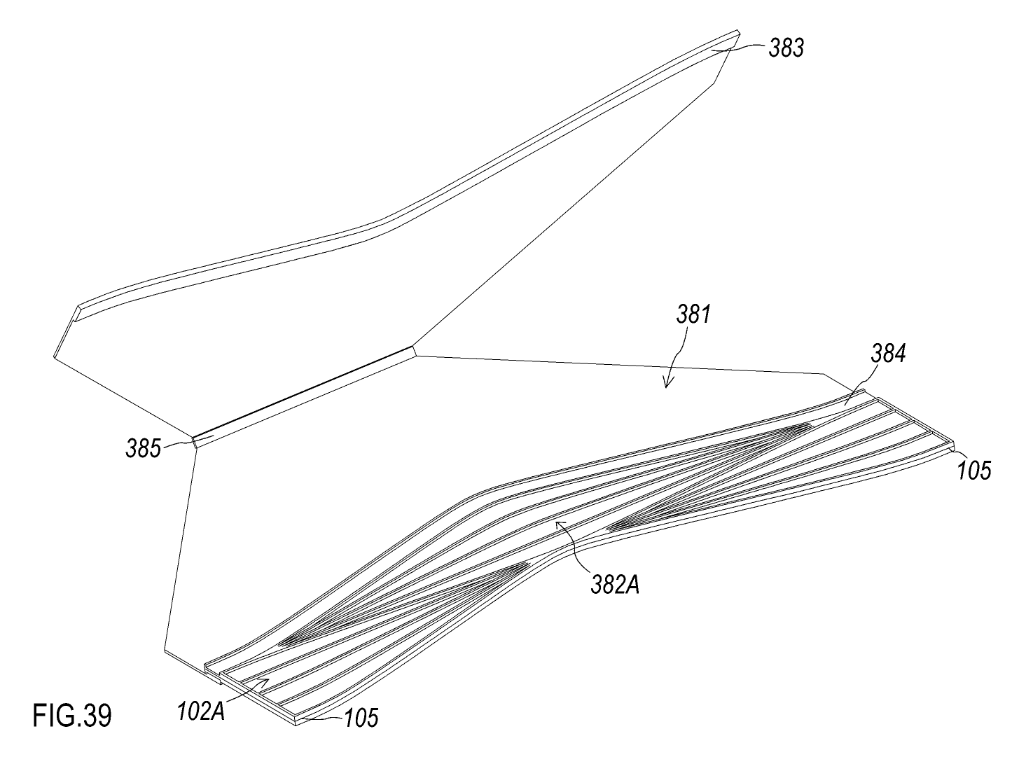

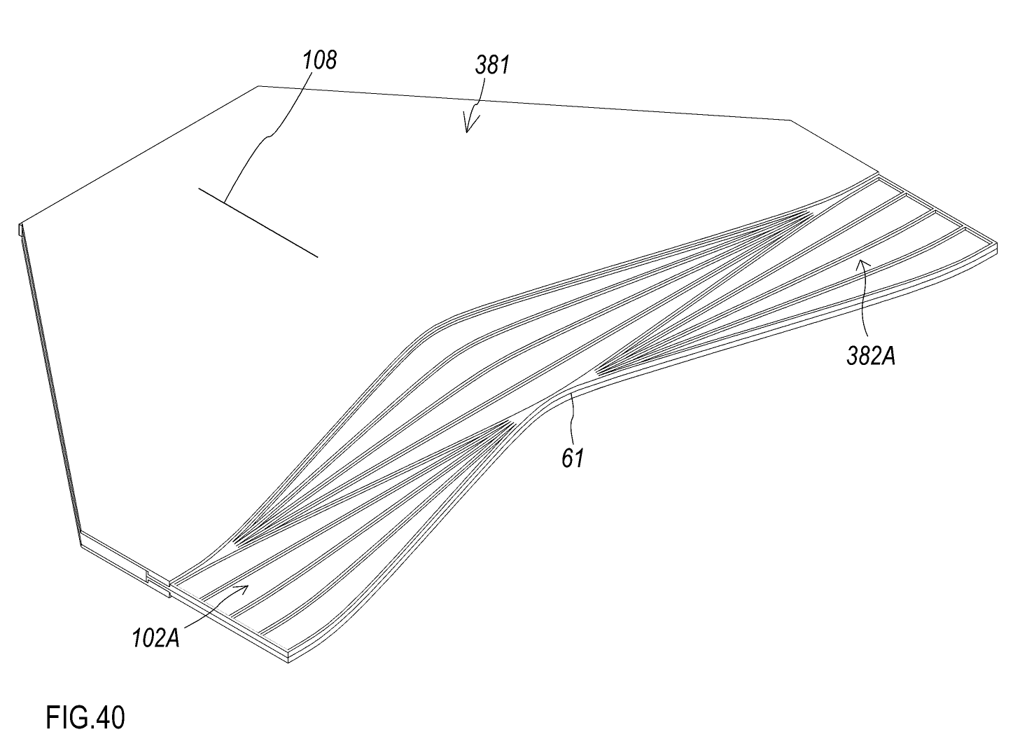

FIGS. 38-40 show a system including a handle 381 and an applicator card 382A having two counterparts of the primary region 102A separated by laterally spaced counterpart of the hinge element 105. The applicator card has a pair of laterally extending channels 384 on opposite sides of the hinge pair that lockingly engage with corresponding laterally extending projections 383 that are formed on the handle 381 when the card in its folded condition is enveloped by the handle, a counterpart of the leading edge 61 being formed by the folded applicator card 382A.

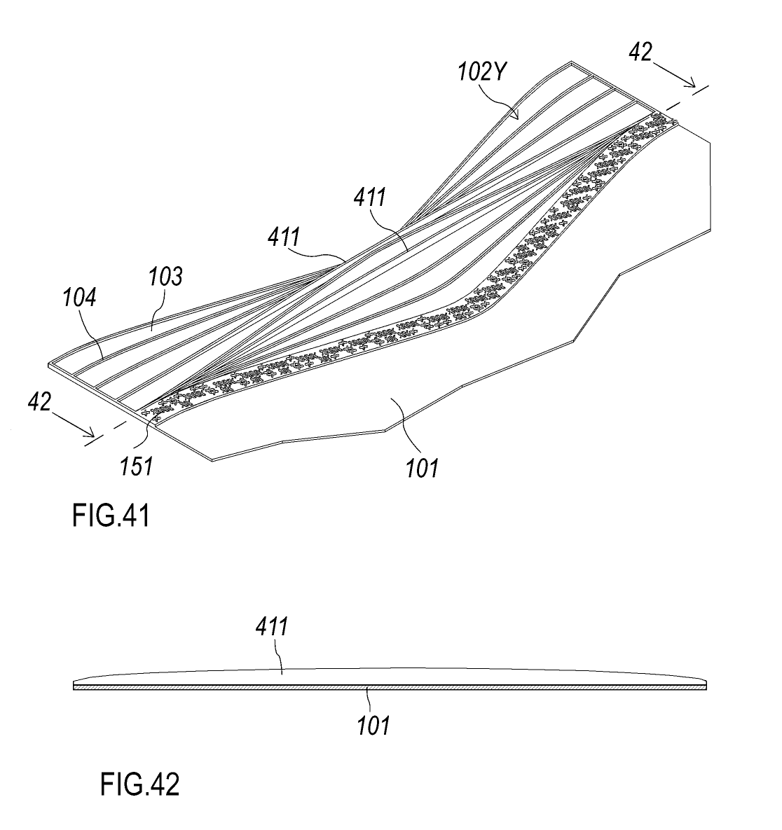

With further reference to FIGS. 41 and 42, counterparts of the wall-like projections 104 can have irregular heights for allowing different quantities of lip cosmetics to pass through during the application process. The part of the wall that is lower than adjacent part will allow more lip cosmetic compound to pass through. More particularly, an example of this feature is embodied with a primary region 102Y formed on a counterpart of the base support 101 and including counterparts of the wall-like projections, designated 411, that are tapered toward opposite ends thereof. As further shown in FIGS. 41 and 42, a counterpart of the irregular surface 151 having elevations and valleys, described above in connection with FIG. 15, is included for increasing the mix of different cosmetic compounds during the application process.

The aforementioned small-delimited cells may have a multiplicity of small projections extending and penetrating through the cosmetic coat for limiting pressure of the lips against the cosmetic coat during the application process.

The base support the present invention can include paper, card stock, wood, rubber, a thermoplastic film, foam, nonwoven, textile, felt, netting, polypropylene, polyethylene, polyethylene tera-phthalate, polyamide, styrenic block copolymers, polyurethane, polyvinyl chloride or blends thereof, or any other suitable material. The cell walls can be formed by embossing, reverse embossing, slitting, aperturing, thermoforming, laminating, etc. Also, visually differentiated lip cosmetic compositions can be filled into the cells by flexography, silk screen printing, painting, heat transfer printing, bubble jet printing, gravure, etc.

### Operation

The manner of using the multi-pattern lip cosmetic applicator such as that described in FIGS. 1-7 to apply lip cosmetics on the epidermal layer of a user's lips is to fold an applicator on its hinge 105 with the face surface 120 facing outside in opposite directions. FIG. 5 shows a perspective view of multi-pattern lip cosmetic applicator partially folded on its hinge; FIG. 6 shows a perspective view of a folded applicator with its leading edge 61 substantially parallel to the width 107 and the holder 62 with the midline indicator 108. FIG. 7 shows a side view of a lip cosmetic applicator folded with the primary regions 102A facing oppositely and ready to be used.

FIG. 8 shows a person using the folded multi-pattern lip cosmetics applicator shown on FIG. 7. The applicator is held by the holder 62 with the primary region 102A placed between the lips with the leading edge 61 inward. The mid-line indicator 108 helps align the applicator with the mid-line of the user's lips.

When thereupon the lips are pressed against the primary region 102A while moving the multi-pattern lip cosmetic applicator inward and/or outward, the rubbing action of the lips against the coat of lip cosmetics along the length 106 of the primary region results in transferring a thin layer of lip cosmetic simultaneously to both of the user's lips. The wall-like projections 104 separate different lips cosmetic compositions and keep them apart before it is ready for use and have a squeegee effect by limiting the quantity of lip cosmetics that are transferred to the lips which results in a uniform deposition without lumps. Further, by limiting the quantity of lip cosmetics that pass through, an area is created where different lip cosmetics which were held back are caused to mix. The user repeats this operation until a desired coating of lip cosmetics is transferred.

Due to the nature of lip cosmetic formulations, they mix easily. Therefore, where bands of different lip cosmetic compounds overlap along the width 107 of primary region, they readily mix during the application process. The proportion of each compound in the mixture that transfers to the user's lips is relative to the length of each band where they overlap along the width 107.

FIG. 9AA shows face view of a primary region with its small-delimited surfaces 103 coated with two different lip cosmetic compositions 42 and 43. The lip cosmetic compositions 42 and 43 form bands that overlap along the width 107. Where those different bands overlap, mix occurs during the application process. Wider the band, more of the cosmetic composition contributes to the mixture that transfers to the user's lips. The FIG. 9A shows the result on the user's lips after using the primary region showed in the FIG. 9AA, the relative proportions of the components being further indicated in FIG. 43. Thus the lip compound mixture deposited along the user's lips gradually changes with more lip compound 43 on region 43H (side of the lips) to less lip compound 43 on region 43L (middle of the lips). The contribution of lip cosmetic compound 42 to the mixture deposited on the user lips is more on region 42H (middle of the lips) and less on region 42L (side of the lips). The contribution of each lip cosmetic compound to the mixture deposited along the use's lips varies gradually, since the length of the cosmetic band gradually changes along its width 107.

Different saturations and values of a particular hue may be achieved by using lip cosmetic compounds with less or no pigment 41. For example, FIG. 9BB shows a pattern having the cosmetics 41, 42, and 43, the results being shown in FIG. 9B and plotted in FIG. 44. The lip cosmetic compounds 42 and 43 mix with lip cosmetic compound 41 during the application process, which will dilute their pigments. The regions of lips with more pigments are shown as 42H and 43H, the regions with less pigments are shown as 42L and 43L; in between, the transition is gradual because the length of those bands change gradually along the width 107 of primary region. Advantageously, the total amount of the cosmetics is substantially uniform across the length 107. Similarly, FIG. 9CC shows another pattern having the cosmetics 41 and 43, the results being shown in FIG. 9C and plotted in FIG. 45; FIG. 9DD shows yet another pattern having the cosmetics 41 and 43, the results being shown in FIG. 9D and plotted in FIG. 46. The lip cosmetic compound 43 mixes with lip cosmetic compound 41 during the application process, which dilutes the pigments of compound 43. The regions of lips with more pigment are shown as 43H, the region with less pigment are shown as 43L

It is seen from the foregoing that with this embodiment, a multitude of different patterns are possible with just one primary region design 102A.

Two or more primary regions may combine in a new one by enveloping different applicators and leaving the primary regions of enveloped applicators exposed as described above.

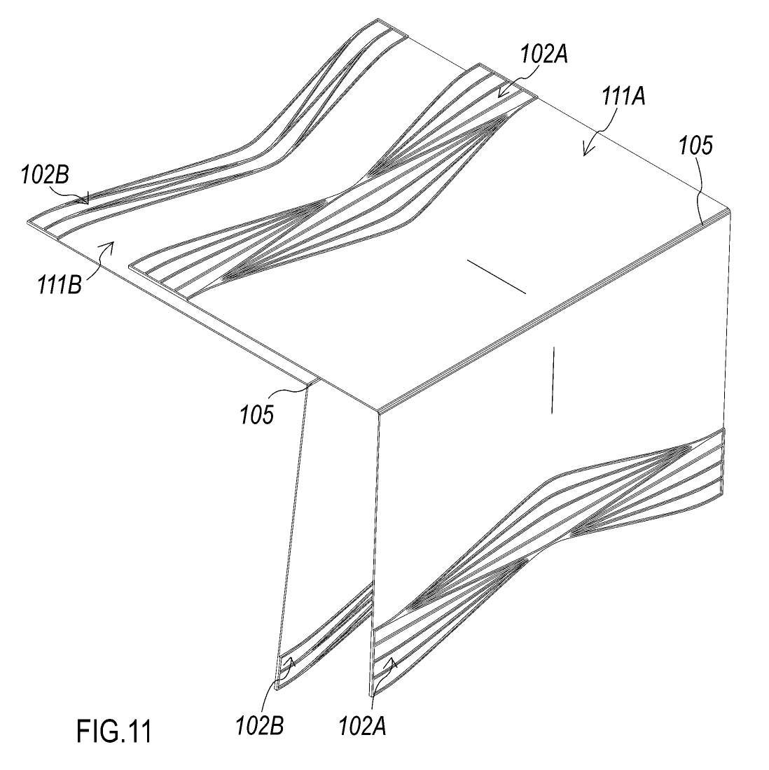

FIG. 10 shows two-lip applicator 111A and 111B with respective primary regions 102A and 102B. The FIG. 11 shows the applicator 111B partially enveloped by the applicator 111A. The FIGS. 12 and 13 show applicator 111B enveloped by applicator 111A, which create a new primary region 102AB with the combined leading edge 61, length 126 and width 127.

The enveloping system combines multiple applicators and works in the same way as one individual applicator with the advantage of multiplying the variety of designs and patterns of primary regions.

FIGS. 14 and 15 show the same applicator 111A enveloping two different applicators 111C and 111D with their respective primary regions 102C and 102D.

FIG. 16 shows the applicator 111A being enveloped by applicator 111E.

From the aforementioned description, those skilled in the art will see that the multi-pattern lips cosmetic applicator of the present invention is uniquely capable of providing a multitude of possible patterns, easily operable both quickly and correctly.

In summary, several advantages of the present invention include one or more of the following:

(a) It provides a convenient way to apply lip cosmetics in a multitude of patterns of colors and textures to the lips;

(b) It provides a way to apply lip cosmetics in a smooth and gradual transition between multitudes of hues and textures to the lips;

(c) It provides a way to apply lip cosmetics in smooth color gradations of different tints, tones, shades, saturations and values of the same hue to the lips;

(d) It provides a way to apply lip cosmetics that is easily operable both quickly and correctly;

(e) It provides a way to apply lip cosmetics that accommodates different sizes and shapes of lips;

(f) It provides a way to apply lip cosmetics that is clean, hygienic and safe.

(g) It provides a way to apply lip cosmetics that can be stacked without smearing the lip cosmetic compounds;

(h) It provides a way to apply lip cosmetics which allows for extremely rapid, convenient and economical changes of patterns produced.

(I) It provides a way to apply lip cosmetics that can be supplied in one pattern or in a multitude of different pattern and may be thrown away after having been once used.

Although the present invention has been described in considerable detail with reference to certain preferred versions thereof, other versions are possible. Therefore, the spirit and scope of the appended claims should not necessarily be limited to the description of the preferred versions contained herein.

1. A multi-pattern applicator comprising:
a. a base support having a face surface adapted for movement in a stroke direction when pressed against a resilient body, the face surface having a primary region thereon, the primary region having an overall width transverse to the stroke direction;
b. the primary region being subdivided into a plurality of delimited cells by walls rising from the face surface, at least some of the walls individually and/or collectively extending transversely relative to the stroke direction within an effective width of the primary region; and
c. a cosmetic compound applied within the primary region between the walls, the compound being adapted for transfer to an external resilient body when the base support is moved inwardly and/or outwardly in the stroke direction with the face surface pressed against the resilient body, the compound being applied in a predetermined relative proportion across the effective width of the primary region.

2. The multi-pattern applicator of claim 1, wherein at least a portion of the primary region has localized lengths less than the overall length.

3. The multi-pattern applicator of claim 1, wherein at least some of the walls project to irregular heights from the face surface.

4. The multi-pattern applicator of claim 1, wherein at least some of the cells form bands having varying length along the width of the primary region.

5. The multi-pattern applicator of claim 1, wherein an irregular surface texture comprising small elevations and valleys is formed within at least a portion of the primary region.

6. The multi-pattern applicator of claim 1, wherein the primary region is one of a plurality of primary regions forming a composite primary region.

7. The multi-pattern applicator of claim 1, comprising a plurality of base supports lockingly engaging a handle element.

8. The multi-pattern applicator of claim 1, wherein the base support projects in the stroke direction beyond the overall length of the primary region sufficiently to form a handle.

9. The multi-pattern applicator of claim 1, wherein the primary region is one of two primary regions separated by a hinge element for facilitating folding of the base support into a folded condition wherein the primary regions face outwardly for use against a facing pair of resilient bodies.

10. The multi-pattern applicator of claim 1, wherein the base support further comprises engagable elements for facilitating positioning a plurality of base supports in orientations wherein primary regions thereof face outwardly for use against a facing pair of resilient bodies.

11. A multi-pattern applicator comprising:
a. a base support having a face surface adapted for movement in a stroke direction when pressed against a resilient body, the face surface having a primary region thereon, the primary region having an overall width transverse to the stroke direction;
b. the primary region being subdivided into a plurality of delimited cells by walls rising from the face surface, at least some of the walls individually and/or collectively extending transversely relative to the stroke direction within an effective width of the primary region;
c. a plurality of cosmetic compounds applied within the primary region between the walls, the compounds being adapted for transfer to an external resilient body when the base support is moved inwardly and/or outwardly in the stroke direction with the face surface pressed against the resilient body; and
d. the small delimited cells having particular ones of the cosmetic compounds forming bands of varying length along the width of the primary region, the compounds being applied in a predetermined relative proportion across the effective width of the primary region.

12. The multi-pattern applicator of claim 11, wherein at least some of the walls project to irregular heights from the face surface.

13. The multi-pattern applicator of claim 11, wherein an irregular surface texture comprising small elevations and valleys is formed within at least a portion of the primary region.

14. The multi-pattern applicator of claim 11, wherein the primary region includes a plurality of pattern regions, the pattern regions being separated by one or more of the walls, different cosmetic compounds being applied in at least two of the pattern regions.

15. The multi-pattern applicator of claim 11, wherein the different cosmetic compounds are of different colors.

16. The multi-pattern applicator of claim 11, wherein the primary region is one of a plurality of primary regions forming a composite primary region.

17. The multi-pattern applicator of claim 11, comprising a plurality of base supports lockingly engaging a handle element.

18. The multi-pattern applicator of claim 11, wherein the base support projects in the stroke direction beyond the overall length of the primary region sufficiently to form a handle.

19. The multi-pattern applicator of claim 10, wherein the primary region is one of two primary regions separated by a hinge element for facilitating folding of the base support into a folded condition wherein the primary regions face outwardly for use against a facing pair of resilient bodies.

20. The multi-pattern applicator of claim 11, wherein the base support further comprises engagable elements for facilitating positioning a plurality of base supports in orientations wherein primary regions thereof face outwardly for use against a facing pair of resilient bodies.

21. A multi-pattern applicator system comprising:
a. a plurality of applicators, each applicator comprising:
i. a base support having a primary region on a face surface thereof for movement in a stroke direction when pressed against a resilient body, the primary region having an overall width transverse to the stroke direction;
ii. the primary region being subdivided into a plurality of delimited cells by walls rising from the face surface, at least some of the walls individually and/or collectively extending transversely relative to the stroke direction within an effective width of the first primary region; and
iii. a cosmetic compound applied within the primary region between the walls, the compound being adapted for transfer to the resilient body when the base support is moved inwardly and/or outwardly in the stroke direction with the face surface pressed against the resilient body, the compound being applied in a predetermined relative proportion across the effective width of the primary region; and
b. means for maintaining the base supports in a partially overlapped condition with at least portions of the primary regions being exposed to form a composite primary region for applying respective cosmetic compounds in predetermined relative proportions across an effective width of the composite primary region.

22. The applicator system of claim 21, wherein at least one base support has at least one aperture formed therein for exposing the primary region of a different applicator.

23. The applicator system of claim 21, wherein at least one base support further comprises an additional primary region, the primary regions thereof being separated by a hinge element for facilitating folding of the at least one base support into a folded condition wherein the primary regions thereof face outwardly for use against the facing pair of resilient bodies.

24. The applicator system of claim 23, wherein the at least one base support has at least one aperture formed therein for exposing one or more primary regions of a different applicator.

25. The applicator system of claim 21, wherein at least one base support projects in the stroke direction beyond the overall length of the primary region sufficiently to form a handle.

26. The applicator system of claim 21, wherein the means for maintaining comprises at least some of the base supports further comprising engagable elements for facilitating positioning those base supports in desired relations.

27. The applicator system of claim 26, wherein the at least some base supports have slidingly engagable rail and track elements for guiding the corresponding applicators to a desired relative position.

28. A method for applying a predetermined combination of cosmetic compounds to a resilient body, comprising the steps of:
a. providing an applicator comprising:
i. a base support having a primary region on a face surface thereof and being subdivided into a plurality of delimited cells by walls rising from the face surface, at least some of the walls individually and/or collectively extending transversely relative to the stroke direction within an effective width of the primary region;
ii. a plurality of cosmetic compounds applied within the primary region between the walls and forming bands of varying length along the width of the primary region;
b. pressing the face surface against the resilient body; and
c. moving the base support inwardly and/or outwardly in the stroke direction, the compounds being applied in a predetermined relative proportion across the effective width of the primary region.

29. A method for making a multi-pattern cosmetics applicator, comprising the steps of:
a. providing a base support having a face surface;
b. forming walls rising from the face surface defining a primary region being subdivided into a plurality of delimited cells, at least some of the walls individually and/or collectively extending transversely within an effective width of the primary region; and
c. applying a plurality of cosmetic compounds within the primary region between the walls and forming bands of varying length along the width of the primary region, the compounds being adapted for transfer to an external resilient body when the base support is moved with the face surface pressed against the resilient body inwardly and/or outwardly in a stroke direction perpendicular to the effective width, thereby to form the cosmetics applicator.
